(19) United States
(12) Patent Application Publication
(10) Pub. No.: US 2021/0291180 A1
(43) Pub. Date: Sep. 23, 2021

(54) MICROFLUIDIC VALVES AND DEVICES

(71) Applicant: SENZO HEALTH LIMITED, Altrincham (GB)

(72) Inventors: Aron RACHAMIM, London (GB); Matthew DAVIES, London (GB); Luis GARCIA- GANCEDO, London (GB); Andreas PROGKIDIS, Shefford (GB)

(21) Appl. No.: 17/117,027

(22) Filed: Dec. 9, 2020

Related U.S. Application Data
(62) Division of application No. 15/566,322, filed on Oct. 13, 2017, now abandoned.
(60) Provisional application No. 62/155,470, filed on Apr. 30, 2015.
(60) Provisional application No. 62/156,368, filed on May 4, 2015.

(51) Int. Cl. B01L 3/00

(52) U.S. Cl. CPC B01L 3/502738; B01L 3/50273; B01L 2300/0816; B01L 2400/0655; B01L 2300/123; B01L 2400/043; B01L 2300/0887

(57) ABSTRACT

A microfluidic valve assembly and a microfluidic sensing platform are provided. The valve assembly has particular utility for separating test fluids from being in contact with a soft substrate, for example, a PDMS substrate. The valve member includes a stretchable membrane positioned to seal a fluid channel. The microfluidic sensing platform is particularly suited for detecting and/or quantifying the presence of one or more target agents in a fluid sample. This system includes a microfluidic chip configured to receive a capture agent and detection agent; a controller configured to control flow of a capture agent and a detection agent; and a sensor configured to detect results of the interaction between the target agents and the mixture of the capture agent and the detection agent.

### RELATED APPLICATION

This application is a Divisional of U.S. application Ser. No. 15/566,322 filed on Oct. 13, 2017, which is a national phase of PCT Patent Application No. PCT/EP2016/059660 filed Apr. 29, 2016, which claims the benefit of priority of U.S. Provisional No. 62/155,470, entitled “Microfluidic Valve Assembly”, filed on 30 Apr. 2015 and United States Provisional Application No. 62/156,368 entitled “Microfluidic Sensing Platform”, filed on 5 May 2015.

The contents of the above applications are all incorporated by reference as if fully set forth herein in their entirety.

### FIELD

This technology relates to microfluidic devices and valves and, more specifically, to microfluidic devices incorporating a valve for selectively controlling the flow of a fluid within the microfluidic device. The technology also relates to a microfluidic system and method for detecting and/or quantifying the presence of one or more target agents within a fluid.

### BACKGROUND

Microfluidics, which include control of a fluid at the micro and nanoscale, finds many applications. One area is in the processing of small amounts of biological fluids, for example, blood. Specifically, a biological fluid can be processed on a microfluidic chip in order to determine the fluid composition and to quantify the presence of certain biomarkers in the fluid. This can be used in many applications including medical diagnostics.

One of the advantages of microfluidics in medical applications includes the ability to use smaller amounts of biological fluids to carry out various tests. For example, a finger prick blood drop may be used for many medical tests instead of a whole syringe of blood. Other advantages of microfluidics also include the ability to use fewer reagents to carry out reactions required for medical diagnostic tests compared with the same tests at the macro scale. The smaller size of microfluidic devices, such as microfluidic chips and any associated instrumentations, confers a significant advantage over traditional lab systems. In particular, the microfluidic devices may allow performing tests at a point-of-care, for example, at a clinic or even at a patient's home.

Conventionally, there are widely used fluid valves in microfluidic industry, such as blade-type actuators, which allow restricting or adjusting a fluid flow in a microfluidic channel. With the help of fluid valves, most conventional systems are able to provide controlled flows of sample fluids into multiple sections or channels on a microfluidic chip. When such valve arrangements fail to close the fluid flow, test results could become inaccurate. Further, complex valve elements can be implemented, but the manufacture of assemblies using such valve elements is expensive and provides only a one-use test arrangement, since such microfluidic arrangements are difficult or impossible to maintain and re-use.

Further, in microfluidics, the quality of valve assembly is important to ensure that precise amounts of fluid can be moved through channels in a microfluidic chip and that different fluids can be moved into specific microfluidic structures (such as wells, channels, and the like) in a microfluidic chip as, and when, desired. Conventionally, the valves on a microfluidic chip, or microfluidic valves, consists of both passive valves (e.g., capillary valves) and active valves, which are controlled through an actuation force. The most common type of active valves includes a fluid channel, where the liquid or liquids of interest run through, and a control channel filled with a control fluid, for example, air or hydraulic fluid that runs through the control channel. The control channel and fluid channel may have a stretchable material therebetween. When the pressure in the control channel is increased, the stretchable material expands and obstructs the flow within the fluid channel. The most popular example of these systems is the Quake valve and the doormat-style valve systems. The Quake valve is normally open and when an increased air pressure is applied through a control channel, the stretchable material expands to close the flow channel.

In the doormat-type valve, when the air pressure of the control channel is sufficient, the valve is shut as the stretchable material forms a closed contact with a pillar or other structure which prevents passage of the liquid. When the air pressure is less than the liquid pressure inside the fluid channel, then the liquid forces open the valve, by stretching the stretchable material. Therefore, these type of valves are known as normally closed valves since they are closed in the relaxed state of the stretchable material. Quake valves and doormat-type valves are constructed solely out of a single stretchable material, for example, polydimethylsiloxane (PDMS) as one of the most stretchable solid materials. This material, however, has some disadvantages for medical diagnostic applications. Many such stretchable materials have significant limitations for use in microfluidic devices, especially in diagnostics. For example, PDMS expands and contracts considerably depending on environmental factors such as temperature and humidity, and it is, therefore, difficult to have precise control over its component features, such as dimensions, for structures machined, moulded or otherwise manufactured into such materials.

Control over feature dimensions and other related factors are essential for controlling fluid flow precisely, which is necessary for obtaining precise results of diagnostic tests. Secondly, for many such materials, especially PDMS, it is difficult to stably functionalize the surface of the material. This is because the soft nature of the material causes the polymer chains to constantly move relative to each other so the surface constantly changes in composition. Without stable functionalization, the surface remains open for components of complex media (for example, proteins) to bind to the PDMS, which can lead to blockage of the channels and also a change in concentration of target analytes. Accordingly, it is preferred to avoid contact of the stretchable membrane such as PDMS, with the complex analyte. Hence, there is a long felt, but still unresolved, need for a microfluidic valve assembly, which can substantially separate test fluids from contacting with a stretchable membrane or other related soft elements.

Current standard target agent quantification tests, such as sandwich or competitive ELISA on 96 well plates, can be used to determine presence and quantities of target agents such as proteins in samples in laboratory systems. Many tests, e.g. for toxicity or certain human diseases, require measurement of multiple protein markers in the sample being tested and this can be done simultaneously with such laboratory systems. However, often it is the case that the utility of the test would be increased if it could be performed away from the lab, for example if a disease diagnostic test could be performed by the doctor or nurse in their office or even at a patient's home, i.e. a mobile or point-of-care format, potentially increasing significantly the utility of the test as well as transforming disease treatment and patient care.

Alternative examples of increased utility of a mobile system are for food testing where it may save costs or be otherwise useful to measure concentrations of particular proteins (including toxins) during food production on the actual production line and water testing, where it could be useful to be able to measure concentrations of one or more molecules such as proteins or salts in rivers or during water treatment. A further consideration is that lab tests using 96 well plates or other formats require relatively large quantities of sample per well. An example where this is an important consideration is again in medical diagnostic testing where the quantity of sample is limited by what can be obtained easily and/or without discomfort to the patient and the optimum would be diagnostics which work from a tiny finger prick sample of blood or similar quantities of other peripheral fluid. Therefore, the transformation of such target agent, particularly protein, quantification lab tests into a small form factor integrated and automated format are needed. This has proven difficult, especially for example in the case where simultaneous measurement of multiple proteins is needed. The process of taking a lab based test and turning it into a small form factor or mobile format is currently an intensive and time consuming process as current methods for transforming the lab-based test into a mobile format have steps which add considerable R&D time and/or reduce the sensitivity of the protein measurement. An example of such is the current case where many mobile formats utilise “multiplex” measurement. In a lab test often it is the case that only one protein in the sample may be measured per well, hence only one set of capture and detection antibodies may be used per well. However, in the “multiplex” format the capture antibodies are placed in the same chamber or channel and the same sample is run over all the capture antibodies at the same time, followed by a free flowing mixture of detection antibodies. The advantages of this type of system are the simplicity of the microfluidic design and the little sample used (since the single quantity of sample is examined to determine levels of all proteins). However, there can be severe problems due to non-specificity and cross-reactivity of antibodies and this adds an extra layer of complexity and uncertainty to the process of transferal from the lab test. For each extra protein which is determined to be measured in the same sample the complexity of the chemistry is increased substantially since there may be non-specific binding and cross-reactivity issues with any one or more of the antibodies and other proteins to be measured. Furthermore, this flow of the sample over all capture antibodies followed by flow of all detection antibodies everywhere is not very well controlled so it can reduce the sensitivity of detection, compared to a lab test where the sample sits in a specific quantity with a well-defined quantity of antibodies and the development of a colour change or other method used for detection takes place only on the static volume of fluid in the well, the volume of which is also well defined by the volume placed in the well. The present disclosure addresses at least one of these problems.

It will be appreciated that reference herein to “preferred” or “preferably” is intended as exemplary only.

### SUMMARY

The microfluidic valve assembly disclosed herein overcomes one or more of the above-stated drawbacks. In particular, it addresses a need for separating test fluids from being in contact with a soft substrate, for example, a PDMS substrate.

According to a first aspect of this disclosure, there is provided a microfluidic valve assembly comprising: (i) a rigid substrate having at least two adjacent layers defining a fluid channel, wherein the at least two adjacent layers include a first layer and a second layer; (ii) at least one valve member comprising a stretchable membrane positioned to seal the fluid channel such that the stretchable membrane is substantially separated from the fluid channel, wherein the stretchable membrane is secured to the first layer, and wherein the at least one valve member is operable based on a difference in a pressure present within the fluid channel and a pressure or a force acting on the membrane from an area being outside of the fluid channel.

In certain embodiments, a cross sectional area of the valve member is different from a cross sectional area of the fluid channel. In certain embodiments, the stretchable membrane is substantially parallel to each of adjacent layers. In certain embodiments, the pressure present in the fluid channel includes a fluid pressure. In certain embodiments, a test fluid is configured to flow through the fluid channel. In certain embodiments, the stretchable membrane of the at least one valve member is configured to expand and contact one of the layers to close the flow of the test fluid in the fluid channel. In some embodiments, a section of the second layer opposing the valve member is configured to protrude towards and contact the stretchable membrane to define a pillar member in the fluid channel, where the stretchable membrane is configured to contract outwards the fluid channel to allow the flow of the test fluid over the pillar member in the fluid channel. In certain embodiments, the stretchable membrane of the valve member is configured to be stably positioned above the pillar member to close the flow of the test fluid in the fluid channel. In yet more embodiments, the pillar member is free of contact from the stretchable membrane and positioned below the stretchable membrane, wherein the stretchable membrane is configured to contract outwards the fluid channel to allow the flow of the test fluid in the fluid channel, and the stretchable membrane is configured to expand towards the upper surface of the pillar member to close the flow of the test fluid in the fluid channel. In certain embodiments, the first layer comprises at least one through hole configured to facilitate a communication between the fluid channel and the valve member positioned above the first layer to facilitate the flow of the test fluid substantially above the fluid channel. In some embodiments, a cross sectional area of the valve member is different from a cross sectional area of the fluid channel. In yet more embodiments, the stretchable membrane of the valve member is embedded with magnetic beads, wherein the valve member is configured to be actuated via magnetic power. In other embodiments, the valve member is configured to be actuated by electrostatic force or electromagnetic power.

According to a second aspect of this disclosure, there is provided a microfluidic valve assembly. The microfluidic valve assembly comprises a rigid substrate with a plurality of layers comprising a first layer, a second layer, and a third layer. The first layer and the second layer defining a control channel. The second layer and the third layer defining a fluid channel. The microfluidic valve assembly further comprises at least one valve member comprising a stretchable membrane positioned to seal the control channel such that the stretchable membrane is substantially separated from the fluid channel. The at least one valve member is operable based on a difference in pressures present in the fluid channel and the control channel.

In some embodiments, the pressures present in the fluid channel and the control channel include fluid pressures. In certain embodiments, a test fluid is configured to flow through the fluid channel, and a control fluid is configured to flow through the control channel. In certain embodiments, the stretchable membrane of the at least valve member is configured to expand and contact the third layer to close the flow of the test fluid in the fluid channel when the difference in the pressure between the fluid channel and the control channel is negative.

In some embodiments, a section of the third layer opposing the valve member is configured to protrude towards and contact the stretchable membrane to define a pillar member in the fluid channel, where the stretchable membrane is configured to contract towards the control channel to allow the flow of the test fluid over the pillar member in the fluid channel when the difference in the pressure between the fluid channel and the control channel is positive. In certain embodiments, the stretchable membrane of the valve member is configured to be stably positioned above the pillar member to close the flow of the test fluid in the fluid channel when the difference in the pressure between the fluid channel and the control channel is negative.

In certain embodiments, the pillar member is free of contact from the stretchable membrane and positioned below the stretchable membrane, where the stretchable membrane is configured to contract towards the control channel to allow the flow of the test fluid in the fluid channel when the difference in the pressure between the fluid channel and the control channel is positive, and the stretchable membrane is configured to expand towards the upper surface of the pillar member to close the flow of the test fluid in the fluid channel when the difference in the pressure between the fluid channel and the control channel is negative.

In certain embodiments, the second layer comprises at least two through holes configured to facilitate a communication between the fluid channel and the valve member positioned above the second layer (for example cut into the top of the second layer or fabricated into an additional fluid layer above the second layer) to facilitate the flow of the test fluid substantially above the fluid channel, where a cross sectional area of the valve member is different from a cross sectional area of the fluid channel. In some embodiments, a cross sectional area of the valve member is different from a cross sectional area of the fluid channel. In some embodiments, the stretchable membrane of the valve member is embedded with magnetic beads, wherein the valve member is configured to be actuated via magnetic power. In other embodiments, the valve member is configured to be actuated via electromagnetic power. In certain embodiments, a cross sectional area of the valve member is different from a cross sectional area of the fluid channel.

According to a third aspect of this disclosure, there is provided a method for transferring fluids. The method comprises the steps of: (i) providing a rigid substrate with a plurality of layers comprising a first layer, a second layer, and a third layer, where the first layer and the second layer defining a control channel, and the second layer and the third layer defining a fluid channel; (ii) causing a test fluid to flow through the fluid channel; (ii) causing a control fluid to flow through the control channel; and (iii) operating at least one valve member to allow or block a flow of the test fluid through the fluid channel, wherein the at least one valve member comprises a stretchable membrane positioned to seal the control channel such that the stretchable membrane is substantially separated from the fluid channel, where the at least one valve member is operable based on a difference in a pressure of the test fluid present in the fluid channel and a pressure of the control fluid in the control channel.

Suitably, the rigid substrate is made of one of or a combination of, for example, Poly methyl methacrylate (PMMA), Cyclic Olefin Copolymer (COC), Cyclic Olefin Polymer (COP), other hard polymers, other non-polymer materials, such as metals, glass, silicon and so forth. Suitably, the stretchable membrane is made of one or more PDMS, polyurethane, polyester, any other soft or stretchable or elastic polymer, extendable polymer material, soft or stretchable or elastic non polymer or a combination thereof.

According to a fourth aspect of this disclosure there is provided a system for detecting and/or quantifying the presence of one or more target agents comprising:
a microfluidic chip which comprises both a capture agent and a detection agent for each target agent;
loading means configured to load the capture and detection agents into desired positions within the microfluidic chip;
control means configured to control the flow and mixing of each of said agents through said microfluidic chip; and
sensing means configured to detect and/or quantify the presence of said one or more target agents.

In one embodiment, the system comprises a device which comprises the control means and/or sensing means. In one embodiment, the microfluidic chip comprises the control means and/or sensing means. It will be appreciated that when the microfluidic chip comprises the control means and/or sensing means, the device may comprise additional control and/or sensing means, in particular the device may additionally comprise control means for activating the sensing means on the microfluidic chip and reading the output obtained from the sensing means.

In one embodiment, the control means are configured to control the flow and mixing of the capture, detection and target agents as well as any additional reagents required for the detection and/or quantification process. In a further embodiment, the control means are configured to activate and control the sensing means.

According to a fifth aspect of this disclosure there is provided a method of detecting and/or quantifying the presence of one or more target agents which comprises the steps of: loading both a capture agent and a detection agent for each target agent into desired positions within a microfluidic chip; controlling the flow and mixing of each of said agents through said microfluidic chip; and detecting and/or quantifying the presence of said one or more target agents by sensing the interaction between the capture and detection agents and said one or more target agents.

Non-limiting examples of capture and detection agents may be found within the standard definition for protein assays, for example see John R. Crowther,

ELISA Guidebook, 2nd Edition, Methods in Molecular Biology, Vol. 516 published by Springer, ISBN 978-1-60327- 253-7, which is incorporated herein by reference.

In contrast to traditional “multiplex” systems, the system of the present disclosure divides, using channels and wells, the sample into sub-samples. It then controls flow into specific chambers or channels and controls the mixing of the sub-samples with the capture and detection agents so that each sub-sample is used to measure the amount or concentration level of only one target agent and hence is exposed to only one set of capture and detection agents.

Since the quantity of sample used must be very small for improved utility and since the present disclosure potentially requires more channels and/or chambers (individual microfluidic subsystem for the sub-sample and each protein quantification) than a typical “multiplex” system described above to quantify the same number of target agents, therefore the microfluidic subsystem must be very small in volume. Furthermore for highly sensitive target agent quantification to be performed this invention controls entrance and exit of sample fluid and any other fluids (e.g. fluids containing required enzymes, developer chemicals or nanoparticles or any other reagents which form part of the protein detection and quantification system) from the reaction area where the exposure of the target agents to be measured to capture and detect agents and any further reactions and processes necessary for the quantification take place. Different methods are utilised for active control of the fluid flow and to prevent unwanted flow out or into the reaction area. These include physical gates such as magnetic beads, a metal or other material which are actuated to block or open channels using electrostatic, electromagnetic or other control methods (such as direct electrostatic control of fluid flow or certain types of valves). This means that the microfluidic subsystem may also be complex in design to achieve the objective to control the entrance and exit of the various fluids including sample fluid.

Furthermore, in order for measurements to be precise the amount of fluid held inside the microfluidic subsystem should be precisely controlled. Therefore, not only the control but also the dimensions of the microfluidic subsystem should be well determined. The disclosure herein contemplates use of lithographic deposition and other micro- and nano-fabrication techniques that have been developed for microelectronic, MEMS and other microsystem fabrication. In particular, these these techniques are applied to the precise fabrication of the channels on a hard substrate for which such lithographic techniques are optimised (such as silicon as the chip substrate) or alternatively applies lithography to silicon and using it as a mould, or sometimes applies such techniques directly to a soft polymer substrate directly if suitable, or other such micro- or nano-fabrication. It will be appreciated that the on process of fabrication and substrate material is dependent on the design of the microfluidic subsystem. These methods have been developed for extremely precise and complex fabrication so that the objective for the chip design, controlled dimensions whilst preserving the complex design needed to fully achieve the complex subdivision and control of fluids is achieved. Furthermore, this process can be used to integrate certain sensors, such as electrochemical or mass sensors, where the sensors need to be directly exposed to the fluid, onto the chip itself during the fabrication process, so that the fabrication of the sensing element of the chip and the microfluidic subsystem for control of the fluids to the sensing elements can be fabricated as part of a single process. Significantly, the methods used in such micro- and nanofabrication are intrinsically “batch” processes. That is, they utilise methods of lithographic design and process that can easily repeat the same subunit once that subunit is designed and optimised. In fact, typically such methods produce large numbers of the same subunit simultaneously on a single substrate. This is only marginally more difficult and the cost increase to produce many subunits is extremely small. Thus, although designing and optimising the fabrication of the microfluidic subsystem and/or any on chip sensing system is complex work for the measurement of one or the first target agent with one set of capture and detection agents, subsequently the subsystem can be repeated on the chip 100s or more times in a very small area using such “batch” techniques. The subsystems then only need to all be connected to initial fluid inlet/s and fluid outlet/s for a large scale measurement system to be complete. This means that the difficulty to measure large numbers of target agents on the present system is only marginally more difficult and the cost is only marginally more than to measure one protein. Hence in contrast to “multiplex” systems which have massively increasing complexity to adapt to measure larger panels of target agents in samples—the greater the number of proteins needed to be quantified the longer the process and the greater the costs to adapt the multiplex system so that it can achieve this without problems (cross-reactivity, substitution, etc.) between capture and detection agents and/or low sensitivity—the microfluidic chip disclosed herein can quickly and easily be produced to measure and quantify many target agents simultaneously at high accuracy, since capture and detection agents do not need to be varied or substituted from those used in lab systems and chips with high numbers of microfluidic subsystems for measuring very large numbers of target agents can be easily and will be standardly produced.

In one embodiment, the system of the disclosure herein provides the advantage of transforming a standard method for adapting a lab system designed to measure multiple proteins into an automated bench or desktop and/or handheld mobile design for measuring the same. This means, for example, it would be suitable for measuring multiple protein biomarkers in a point-of-care medical diagnostic panel so the accuracy of the panel would be the same as a remote lab test. If such a panel had been designed on a lab system, it could be easily transferred onto the system presently disclosed whilst easily preserving the same accuracy of protein measurement. The process of transferring the diagnostic test to the point-of-care measurement system presently disclosed could be a process of weeks or days instead of the many months currently required to transfer onto “multiplex” or other current diagnostic systems currently available. Furthermore, since the number of target agents measured can be increased easily and with a marginal cost increase—the only linear increase in cost is for the reagents, especially antibodies, however even the quantities of antibodies may be less than for a lab system since smaller quantities of sample fluid and hence reagents are used. It becomes an easy possibility to increase the number of diagnostic panels measured on the same chip so that, for example, multiple diseases could be measured using a single chip. This will increase utility and also potentially reduce costs for medical diagnostic measurement since the cost increase to measure the extra target agents on the system presently disclosed is small. Possibly similar effects can be achieved in food safety measurement and other diagnostics where quantification of certain target agents is necessary.

However, a further complexity of the system described herein is to load the necessary agents (usually but not always or not only a suitable set of capture and detection agents) needed for the sample protein detection onto the chips. In particular, whilst previous systems have recognised the need to load capture agents onto a chip, the present system recognises a requirement to load both capture and detection agents and/or possibly other reagents needed for target agent quantification to specific sites on the chip, from whence their release and mixing with each other can be actively controlled over time. Therefore, apart from the necessity for a chip designed with appropriate channels and chambers described above there is a need for a loading machine to automate manufacture of the chips by loading both one or more sets of capture and detection agents and/or other necessary reagents onto the specific sites on at least one microfluidic chip from whence the timing and process of their mixture and reaction can be fully and actively controlled. In fact, the device will typically be designed to perform fast sequential or parallel loading of all the antibodies and other reagents onto at least one microfluidic chip. Furthermore, usually the loading device is also optimised for high speed sequential or parallel loading of these reagents onto multiple chips as well so that the loading machine enables high volume production of the microfluidic chip.

Preferably, the loading device is configured to provide one or more agents into one or more wells. A loading device may be configured for one type of agent only e.g., a loading device may be configured for the capture agent or a loading device maybe be configured for the detection agent. Embodiments of the invention contemplate a system including one or both types of loading device configurations present in the system.

It will be appreciated that the loading device may be configured to provide one or more reagents into a well or a position other than the capture and/or the detection wells i.e. a third type of a well on a microfluidic chip. In preferred embodiments, a single loading device is configured to provide one or more agents to both the capture well and detection well. In preferred embodiments, the one or more agents are selected from a capture agent and a detection agent, and combinations thereof. The system and methods further comprise at least one loading device configured to provide each capture agents into the correct position of such capture agents within the microfluidic chip and provide each detection agent into the correct position of such detection agent within the microfluidic chip.

According to a sixth aspect, the disclosure is a device into which the microfluidic chip is placed and which performs the analysis, control of the sensing elements on the chip and/or contains suitable sensing elements itself For example, in a case where resonant mass sensors are utilised the device activates electronically the resonance of the sensors and records any change in such, indicating a binding event. In the case where light is transmitted to the sample, reagents or a combination of these e.g. to record a colour change, the device would produce the light and control the exposure of the light so that only the correct part of the microfluidic chip is exposed at a certain time, for example using methods such as liquid crystal display switching or similar, which allows active control of light transmission only to desired pixels. In such a case the device may also read the output signal, which might for example be electrical or might be a modified light signal. It might contain multiple sensing areas, e.g. multiple light sensors, but may also contain only one sensing area, since the active control of the light exposure means that the modified output upon exposure signal must be due only to the exposed area during a single time period. The device produces the electromagnetic or electrostatic fields and/or other forces for the active control of the fluids on each microfluidic chip and automates the control of the mixing of antibodies and/or reagents on the chip so that this is controlled and usually takes place in a way that is exactly analogous to the sequence of steps in the lab test, except only that the reaction takes place on a smaller scale and everything is done through automatic control rather than the manual work of a lab technician. Finally, the device has suitable computational power, software, memory etc. to enable the necessary control processes and recording of the resultant output data and also the processing and storage of the data and to run the software which is the required interface between the non-expert user and the machine. It also has the necessary optical, wired and/or wireless connectivity to transmit data and receive commands and carry out all other necessary and useful communication to other devices as well as the human user.

Thus the disclosure is a complete chain for automating the transformation of a lab based protein assay test, which can only be performed in a suitably equipped lab by trained personnel, into a small form factor (bench top, handheld) automated and integrated protein detection and/or concentration quantification test which can be performed potentially anywhere by personnel with minimal or no training in many different locations, thus significantly increasing the utility of many diagnostic tests. The present disclosure also enables many more tests to be done on the same sample.

Without the specially designed chip with separate repeated sections for individually measuring each target agent it would become increasingly complex to measure the target agents the more target agents there are in the sample. The device controls the movement of fluids through the chip and/or the measurement of each target agent at each point where this is required on the chip and carry out any processing and transmission of the resultant data. The special loading machine is needed so that the user can simply put into the loading machine their fluids containing each capture or detection agent and these will be printed into the exactly required points on the chip. Therefore, all that the user needs to do is prepare individual fluids each fluid containing a different capture or detection agent and they will immediately be able to produce an operating benchtop or handheld product ready for market.

In any one of the aforementioned aspects, additional capture agents, detection agents or other agents are received into one or a plurality of positions or wells with the microfluidic chip. Preferably, these positions or wells are wells or positions as herein described or may be additional positions or wells present on the microfluidic chip.

Additional objects, advantages, and novel features will be set forth in part in the detailed description, which follows, and in part will become apparent to those skilled in the art upon examination of the following detailed description and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments of the present disclosure will now be described by way of example with reference to the accompanying drawings in which:

FIG. 1A illustrates a front sectional view of a microfluidic valve assembly according to one embodiment.

FIG. 1B illustrates the front sectional view of the microfluidic valve assembly shown in FIG. 1A and further showing the expansion of a stretchable membrane to close a flow of a test fluid.

FIG. 2A illustrates a front sectional view of a microfluidic valve assembly according to another embodiment.

FIG. 2B illustrates the front sectional view of the microfluidic valve assembly shown in FIG. 2A and further showing the expansion of a stretchable membrane to close a flow of a test fluid.

FIG. 3A illustrates a front sectional view of a microfluidic valve assembly according to another embodiment, and further showing the contraction of a stretchable membrane to allow a test fluid to flow.

FIG. 3B illustrates a front sectional view of the microfluidic valve assembly as in FIG. 3A, and further showing a normal flat orientation of the stretchable membrane.

FIG. 4A illustrates a front sectional view of a microfluidic valve assembly according to yet another embodiment, and further showing a pillar member with a reduced height.

FIG. 4B illustrates a front sectional view of the microfluidic valve assembly as in FIG. 4B, and further showing the expansion of the stretchable membrane to close the fluid channel.

FIG. 5 illustrates a cutaway view showing a top perspective view of another embodiment of a microfluidic valve assembly.

FIG. 6 shows a schematic view of a microfluidic chip which comprises ‘N’ quantification systems, each quantification system comprising both a capture agent and a detection agent for each target agent. The scale (estimate only) is about 2 cm:about 1 mm.

FIG. 7 shows a schematic view of a microfluidic chip which comprises ‘N’ quantification systems, similar to that shown in FIG. 6 but with additional microfluidic wells. The scale (estimate only) is about 2 cm:about 1 mm.

FIG. 8 shows one possible quantification system in detail. The scale (estimate only) is about 4 cm:about 100 μm.

FIG. 9 shows one possible quantification system in detail, similar to that shown in FIG. 8 but with additional blocking channels and blocking agents. The scale (estimate only) is about 4 cm:about 100 μm.

FIG. 10 shows a loading device suitable to control the flow and mixture of fluids within the chip and suitable to control the sensing means. The scale (estimate only) is about 2.5 cm:about 1 mm.

FIG. 11 shows a loading device wired to a smart infrastructure for device operation control. The scale (estimate only) is about 1 cm:about 1 mm in respect of element 600. The scale in respect of element 605 is about 1.5 cm:about 1 cm.

FIG. 12 shows a loading machine configured to load one or more sets of capture and detection agents and/or other necessary reagents onto the desired positions within the microfluidic chip. The scale (estimate only) is about 1 cm:about 1 mm.

### DETAILED DESCRIPTION

Unless defined otherwise, all technical and scientific terms used herein have the same meaning as commonly understood by those of ordinary skill in the art to which the present disclosure belongs. Although any methods and materials similar or equivalent to those described herein can be used in the practice or testing of the present disclosure, preferred methods and materials are described. For the purposes of the present disclosure, the following terms are defined below.

The articles “a” and “an” are used herein to refer to one or to more than one (i.e., to at least one) of the grammatical object of the article. By way of example, “an element” means one element or more than one element. As used herein, the use of the singular includes the plural (and vice versa) unless specifically stated otherwise.

By “about” is meant a quantity, level, value, number, frequency, percentage, dimension, size, amount, weight or length that varies by as much 15, 14, 13, 12, 11, 10, 9, 8, 7, 6, 5, 4, 3, 2 or 1% to a reference quantity, level, value, number, frequency, percentage, dimension, size, amount, weight or length.

Throughout this specification, unless the context requires otherwise, the words “comprise,” “comprises” and “comprising” will be understood to imply the inclusion of a stated step or element or group of steps or elements but not the exclusion of any other step or element or group of steps or elements. Thus, use of the term “comprising” and the like indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter.

The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

### Microfluidic Valve Assembly

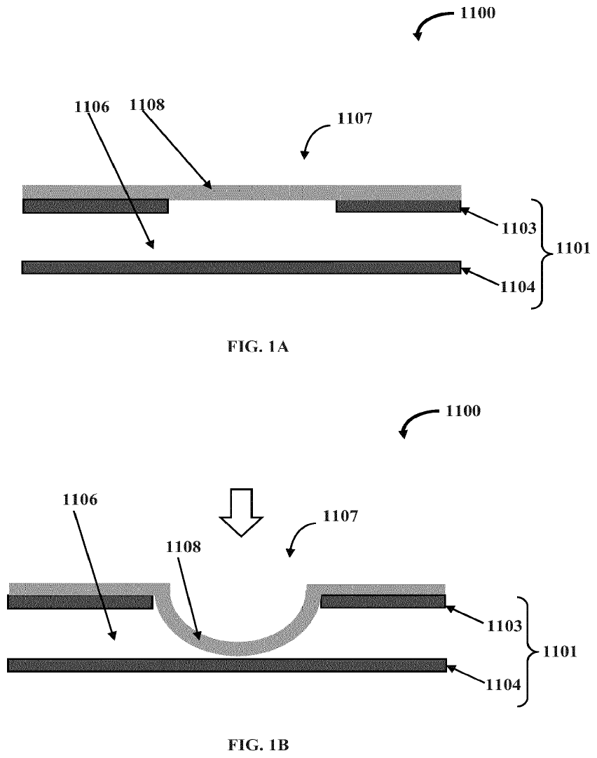

Described herein are microfluidic devices incorporating a valve for selectively controlling the flow of a fluid within the microfluidic device. FIG. 1A exemplarily illustrates a front sectional view of a microfluidic valve assembly 1100 according to one embodiment. The microfluidic valve assembly 1100 includes a rigid substrate 1101 and at least one valve member 1107. The rigid substrate 1101 comprises at least two layers 1103 and 1104. These layers 1103, 1104 define a fluid channel 1106 for transferring test fluids. The valve member 1107 comprises a stretchable membrane 1108 positioned over (and optionally secured to) the layer 1103 such that the stretchable membrane 1108 is substantially separated from the fluid channel 1106. Specifically, as shown in FIG. 1A, the layer 1103 may have a through-hole or an opening of any suitable form, which is covered with the stretchable membrane 1108, such that there a predetermined distance between the inner surface of the layer 1103 and the surface of the stretchable membrane 1108.

The rigid substrate 1101 is made of one of or a combination of, for example, Poly methyl methacrylate (PMMA), Cyclic Olefin Copolymer (COC), Cyclic Olefin Polymer (COP), other hard polymers, other non-polymer materials, such as metals, glass, silicon and so forth. The stretchable membrane 1108 is made of one or more PDMS, polyurethane, polyester, any other soft or stretchable or elastic polymer, extendable polymer material, soft or stretchable or elastic non polymer or a combination thereof.

The valve member 1107 is operable based on applying a force towards the stretchable membrane 1108. The force can be generated in view of a difference of fluid pressures present in the fluid channel 1106 and an area behind the stretchable membrane 1108. In other embodiments, the force can be generated by an actuator, a motor, piezoelectrical device, microelectromechanical (MEMS) device, and so forth. FIG. 1B exemplarily illustrates a front sectional view of the microfluidic valve assembly 1100, showing the expansion of the stretchable membrane 1108 to close the fluid channel 1106 upon application of the outside force onto the stretchable membrane 1108. The outside force is shown by an arrow in this figure.

In an alternative embodiment the structure is the same as shown in FIG. 1A except that a section of the layer opposing the valve member is configured to protrude towards and contact the stretchable membrane to define a pillar member in the fluid channel. The stretchable membrane contracts towards the control channel to allow the flow of the test fluid over the pillar member in the fluid channel when the difference in the pressure between the fluid channel and the external surface of the membrane is negative. The “pillar” as defined herein could be any shape or combination of shapes or comprised of multiple structures separated from each other. In this construction, the PDMS membrane is normally flat against the pillar member in the fluid channel which lies beneath the pneumatic channel or the control channel. When the pressure in the control channel is low, the pressure in the test fluid is higher than the pressure of the control fluid, therefore, the pressure of the test fluid pushes against the PDMS membrane deforming the PDMS membrane to open so that the test fluid can flow over the pillar member and continue into the outlet channel. In an embodiment, the stretchable membrane of the valve member is stably positioned above the pillar member to close the flow of the test fluid in the fluid channel when the pressure on the side of the membrane opposite to the fluid channel is greater than the pressure in the fluid channel. In other words, application of more pressure on the external side of the membrane (the opposite side to that facing the fluid channel) allows the PDMS membrane to be positioned in the flat orientation, pressing the PDMS membrane against the pillar member and blocking the flow of the test fluid. This is a “normally closed” valve structure.

In an alternative embodiment the structure is the same as shown in FIG. 1A except that there is a pillar structure. However in this embodiment the pillar member is free of contact from the stretchable membrane and positioned below the stretchable membrane. The stretchable membrane contracts expands away from the bottom of the fluid layer to allow the flow of the test fluid in the fluid channel when the difference in the pressure between the fluid channel and the pressure on the external surface of the membrane (external , on the opposite side of the membrane from that facing the fluid towards the fluid channel) is positive, and the stretchable membrane is configured to expand towards the upper surface of the pillar member to close the flow of the test fluid in the fluid channel when the difference in the pressure between the fluid channel and the external surface of the membrane is negative.

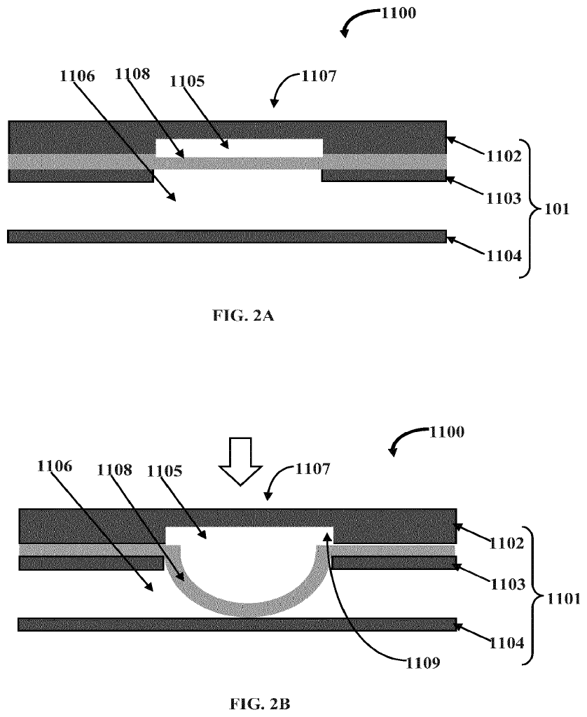

FIG. 2A exemplarily illustrates a front sectional view of the microfluidic valve assembly 1100 according to another embodiment. As shown in the figure, the microfluidic valve assembly 1100 comprises a rigid substrate 1101 and at least one valve member 1107. The rigid substrate 1101 has multiple layers such as a first layer 1102, a second layer 1103, and a third layer 1104. The first layer 1102 and the second layer 1103 defines a control channel 1105, and the second layer 1103 and the third layer 1104 defines a fluid channel 1106. The valve member 1107 comprises a stretchable membrane 1108 positioned to seal the control channel 1105 such that the stretchable membrane 1108 is substantially separated from the fluid channel 1106. The rigid substrate 1101 is made of one of or a combination of, for example, Poly methyl methacrylate (PMMA), Cyclic Olefin Copolymer (COC), Cyclic Olefin Polymer (COP), other hard polymers, other non-polymer materials, such as metals, glass, silicon and so forth. The stretchable membrane 1108 is made of one or more PDMS, polyurethane, polyester, Polyethylene (PE), any other soft or stretchable polymer, extendable polymer material, or a combination thereof. The stretchable membrane 1108 may be a non-polymeric material that is suitably stretchable.

The valve member 1107 is operable based on a difference in pressure (e.g., a fluid pressure) between the fluid channel 1106 and the control channel 1105. In an embodiment, a test fluid is configured to flow through the fluid channel 1106, and a control fluid is configured to flow through the control channel 1105. The term “test fluid,” as used herein, refers to any fluid sample, such as a biological fluid sample, for example, blood, which is extracted for a laboratory test and may include a flowing solid such as but not limited to, a flowing solid such as sand-like particles. In preferred embodiments, the fluid sample is a biological fluid sample and more preferably, blood. The blood sample is allowed to flow through the fluid channel 1106 to test specific amounts of blood in different channel regions. The term “control fluid,” as used herein, refers to any fluid or liquid, for example, air, gas, oil, flowing solid such as sand which is configured to exert a pressure on the stretchable membrane 1108 of the valve member 1107 to actuate the valve member 1107 for example, pneumatically or hydraulically.

FIG. 2B exemplarily illustrates a front sectional view of the microfluidic valve assembly 1100, showing the expansion of the stretchable membrane 1108 to close the fluid channel 1106 and, accordingly, block the flow of the test fluid. In an example, one or more through-holes 1109 are fabricated into the first layer 1102 and second layer 1103 to define a section for the valve member 1107 or the valve points. In an embodiment, the stretchable membrane 1108 of the valve member 1107 expands and contacts the third layer 1104 to close the flow of the test fluid, for example, blood, for analysis or reagents for certain chemical reactions, in the fluid channel 1106, when the difference in the pressure between the fluid channel 1106 and the control channel 1105 is negative as shown by the arrow in FIG. 2B. This arrangement is also advantageous as the valve member 1107 may readily have a different cross section and is therefore easier to seal.

In other words, if the applied pressure of the control fluid, as shown by the arrow in FIG. 2B, is higher than the pressure of the test fluid, the stretchable membrane 1108 of the valve member 1107 expands to close the fluid channel 1106. In construction, a flat PDMS layer is bonded onto or simply held in place on top of a top PMMA layer. A pneumatic layer or the control channel 1105 is defined on top of the PDMS. Multiple channels are cut into the first and second PMMA layers. When pneumatic pressure is applied to the PDMS layer, the PDMS layer is deformed to extend into the fluid channel 1106 to block the flow of the test fluid. This construction is a “normally open” valve structure.

According to various embodiments of the present disclosure, as an alternative to reshaping the PDMS via moulding or other techniques to form the fluid channel 1106 and the control channel 1105, and other features of the microfluidic structure, for example, the microfluidics features, channels, wells, etc., the PDMS substrate is fabricated in a hard polymer substrate, such as PMMA, COC, or COP. According to an embodiment of the present disclosure, the rigid substrate 1101 has certain sections where the stretchable membrane 1108 or the PDMS has access to the test fluid, for example, via through holes in a middle layer of PMMA over which the PDMS membrane is positioned. The design is such that when pneumatic pressure is applied to the PDMS, the stretchable membrane 1108 stretches through the holes into the channel below blocking the flow of the test fluid in the channel below.

Therefore, in the present embodiment, the assembly comprises at least one test fluid channel 1106 together with one stretchable membrane 1108. The stretchable membrane 1108 may or may not have features designed into it. The design of the assembly is such that the stretchable membrane 1108 is in contact with the test fluid in the fluid channel 1106 only at certain points, for example, valve points. Further, when pressure is increased or decreased on the stretchable membrane 1108 pneumatically or hydraulically or by other methods such as mechanic or electromagnetic force, the stretchable membrane 1108 is deformed such that this deformation closes or opens fluid channel 1106. Thus, the overall assembly acts as either a normally open or normally closed valve member 1107. The changes in pressure may apply across the whole assembly simultaneously deforming the stretchable membrane 1108 at multiple “valve points” and causing the flow of the test fluid flow to increase or to be restricted in multiple locations simultaneously across the fluid network.

In an example embodiment, the valve members 1107 are operated through deformation of a flexible membrane or the stretchable membrane 1108 which is only in contact with the test fluid in a fluid network at certain designated points such that an applied pressure to the stretchable membrane 1108 causes the stretchable membrane 1108 to distort into the fluid channel 1106 or other structures in the network, thereby blocking or restricting the pathway of the test fluid at the designated points in the network. Alternatively, the stretchable membrane 1108 distorts such that the pathway of the test fluid is opened enabling increased fluid flow.

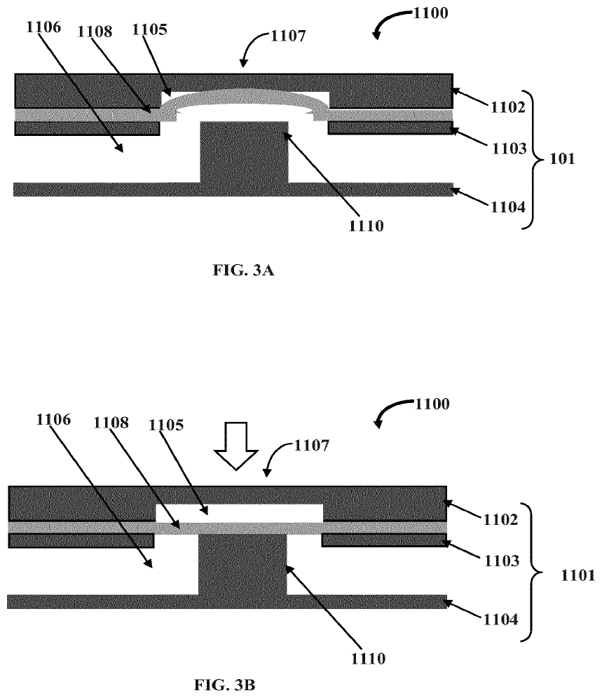

FIG. 3A exemplarily illustrates a front sectional view of an embodiment of the microfluidic valve assembly 1100, showing the contraction of the stretchable membrane 1108 to allow the flow of the test fluid, and FIG. 3B exemplarily illustrates another front sectional view of the microfluidic valve assembly 1100 in FIG. 3A, showing a normal flat orientation of the stretchable membrane 1108. In an embodiment, a section of the third layer 1104 opposing the valve member 1107 is configured to protrude towards and contact the stretchable membrane 1108 to define a pillar member 1110 in the fluid channel 1106. The stretchable membrane 1108 contracts towards the control channel 1105 to allow the flow of the test fluid over the pillar member 1110 in the fluid channel 1106 when the difference in the pressure between the fluid channel 1106 and the control channel 1105 is positive. The “pillar” as defined herein could be any shape or combination of shapes or comprised of multiple structures separated from each other. Preferably, the pillar arrangement is a combination of one or more structures of any shape protruding from the bottom surface.

In construction, the PDMS membrane is normally flat against the pillar member 1110 in the fluid channel 1106 which lies beneath the pneumatic channel or the control channel 1105. When the pressure in the control channel 1105 is low, the pressure in the test fluid is higher than the pressure of the control fluid, therefore, the pressure of the test fluid pushes against the PDMS membrane deforming the PDMS membrane to open so that the test fluid can flow over the pillar member 1110 and continue into the outlet channel. In an embodiment, the stretchable membrane 1108 of the valve member 1107 is stably positioned above the pillar member 1110 to close the flow of the test fluid in the fluid channel 1106 when the difference in the pressure between the fluid channel 1106 and the control channel 1105 is negative. In other words, application of more pressure in the control channel 1105 allows the PDMS membrane to be positioned in the flat orientation, pressing the PDMS membrane against the pillar member 1110 and blocking the flow of the test fluid. This is a “normally closed” valve structure.

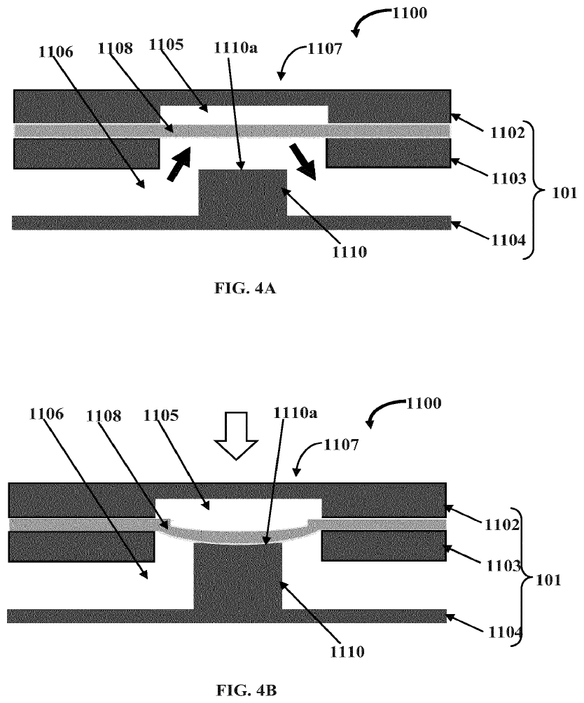

FIG. 4A exemplarily illustrates a front sectional view of another embodiment of the microfluidic valve assembly 1100, showing the pillar member 1110 with a reduced height, and FIG. 4B exemplarily illustrates another front sectional view of the microfluidic valve assembly 1100 in FIG. 4B, showing the expansion of the stretchable membrane 1108 to close the fluid channel 1106. In an embodiment, the pillar member 110 is free of contact from the stretchable membrane 1108 and positioned below the stretchable membrane 1108. The stretchable membrane 1108 contracts towards the control channel 1105 to allow the flow of the test fluid in the fluid channel 1106 when the difference in the pressure between the fluid channel 1106 and the control channel 1105 is positive, and the stretchable membrane 1108 is configured to expand towards the upper surface 1110a of the pillar member 1110 to close the flow of the test fluid in the fluid channel 1106 when the difference in the pressure between the fluid channel 1106 and the control channel 1105 is negative.

In construction, this embodiment incorporates aspects of the embodiments shown in FIGS. 1A-1B, FIGS. 2A-2B, and FIGS. 3A-3B, such that the valve member 1107 incorporates a pillar member 1110, which does not contact the stretchable membrane 1108. The valve member 1107 is, therefore, more flexibly open when the pressure is low in the control channel 1105 and the test fluid can flow. When pressure is increased in the control channel 1105 the valve member 1107 closes. In an example, the test fluid can flexibly flow when pressure is low in the control channel 1105 than in the case of the “normally closed” valve structures, as shown in FIGS. 2A-2B. However, since the space between the stretchable membrane 1108 and the top surface of the pillar member 1110 is less than the regular depth of the fluid channel 1106, it is easier to seal the stretchable membrane 1108 against the pillar member 1110 when pressure is applied in the control channel 1105, hence much easier to close this valve member 1107 than the “normally open” structure as shown in FIGS. 2A-2B.

In an embodiment, a deeper channel depth is maintained throughout most of the structure, except at the valve member 1107, such that, when the cross section of the pathway of the test fluid is greater, there is less resistance to flow of the test fluid and less back pressure in the assembly, therefore it is easier to create or control fluid flow in the assembly. In an example, a larger cross section can also be created by increasing the width of the fluid channel 1106 but this takes up space in the x-y direction on chip, which means the chip needs to be much bigger for same fluid back pressure as there may be very long networks of channels on chip. In exemplary embodiments, each of the control channel and the fluid channel has a width of about 50 μm to about 1 mm and a depth of about 5 μm to 200 μm, inclusive of endpoints, although without limitation thereto. In other exemplary embodiments, the dimensions of the control channel and the fluid channel may be in the nanoscale or the microscale, although without limitation thereto.

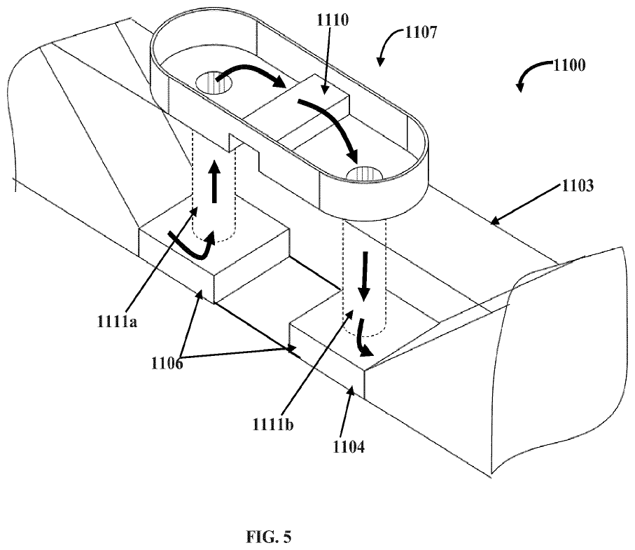

FIG. 5 exemplarily illustrates a cutaway view showing a top perspective view of another embodiment of the microfluidic valve assembly 1100. In this embodiment, the second layer 1103 comprises at least two through holes 1111a and 1111b configured to facilitate a communication between the fluid channel 1106 and the valve member 1107 positioned above the second layer 1103, and to further facilitate the flow of the test fluid substantially above the fluid channel 1106. Further, a cross sectional area of the valve member 1107 is different from a cross sectional area of the fluid channel 1106. A through hole 1111a is bored through the second layer 1103 so that the test fluid is allowed to be transferred through the through hole 1111a to the PDMS valve member 1107 positioned above the second layer 1103. The test fluid flows over the pillar member 1110 when an external pressure over the valve member 1107 is less than the pressure of the test fluid and flows back into the fluid channel 1106 through the through hole 1111b.

In construction, the embodiment in FIG. 5 follows the principles of the embodiments in FIGS. 1A, 1B, 2A, 2B, 3A, 3B, 4A, and 4B. As exemplarily illustrated in FIG. 5, in this embodiment the middle PMMA layer has a through hole 1111a through which the test fluid is transferred from the fluid channel 1106 underneath, towards a valve member 1107 fabricated into the topside of the middle PMMA layer, and then the test fluid is transferred back to the main fluid channel 1106 through another through hole 1111b. The depth of the valve member 1107 is shallower than the main fluid channel 1106 and in this embodiment there is also a pillar member 1110 in the middle of the valve member 1107. The PDMS layer is placed directly above and against the middle PMMA layer. Application of increased pressure from above to the PDMS layer causes a downward deformation blocking the valve member 1107 or the “valve channel”. In an embodiment, the stretchable membrane 1108 of the valve member 1107 is embedded with magnetic beads so that the valve member 1107 is configured to be actuated via magnetic power. In other embodiments, the valve member is configured to be actuated by electrostatic force or electromagnetic power.

In an embodiment, according to FIGS. 4A-4B and FIG. 5, the structure of the valve member 1107 is designed such that the depth of the control channel 1105 at the valve member 1107 is independent of the usual depth of the test fluid in the main fluid channel 1106, since it is difficult to seal these type of membrane valves effectively where the depth of the control channel 1105 at the valve member 1107 is large. However, if the depth of the fluid channel 1106 is generally shallow throughout the fluid network, the cross-section of the fluid channel 1106 will be less for a given channel width. This means that there is greater impedance to the flow of the test fluid, the back pressure is greater and so more pressure is required to allow the flow of the test fluid through the fluid network. Therefore, effective sealing of the fluid network is required so that the test fluid does not leak, which is more difficult at higher pressure and high speed of flow of the test fluid on the chip. Hence the microfluidic valve assembly 1100 is designed such that the depth of the control channel 1105 at the valve member 1107 is independent of the general fluid channel 1106 depth, and the valve member 1107 can be more easily closed while maintaining a lower fluid pressure in the fluid network. Hence, the flow of the test fluid at the valve point is through a pathway, which has an independent, different depth or layer than in the rest of the fluid network.

In another embodiment, the PDMS is poured into a cavity in the hard polymer and allowed to set. In another embodiment, include multiple layers of PMMA layers or rigid layers and PDMS layers or pneumatic layers to enable more complicated fluid pathways and control. In an embodiment, the microfluidic valve assembly 1100 finds application in microfluidic chips and other structures for diagnostics applications and other applications. Further, the valve member 1107 are implemented into macro-scale and nanoscale applications.

### Microfluidic Sensing Platform

The technology described herein also relates to a system and method for detecting and/or quantifying the presence of one or more target agents. In particular, but not exclusively, one example of the utility of the present disclosure is for multiple protein biomarker disease tests, which could be converted using a standard process from a manual lab based protein assay to a desk, benchtop or handheld integrated, automated assay that could be used for testing patients at point-of-care. Certain embodiments of the present disclosure will now be described in order to provide more detailed understanding of the present disclosure and illustrate how it can be applied to the transformation of a lab based target agent quantification test to an integrated desktop or benchtop format.

In one definition, an integrated system is a convenient, possibly modular package comprising all the elements needed for accurate operation. In one definition, an automated system is a system containing a plurality of operationally interdependent components (that can be separated by significant physical distances) requiring minimal or no interaction with an operator for optimum analysis of the sample under test.

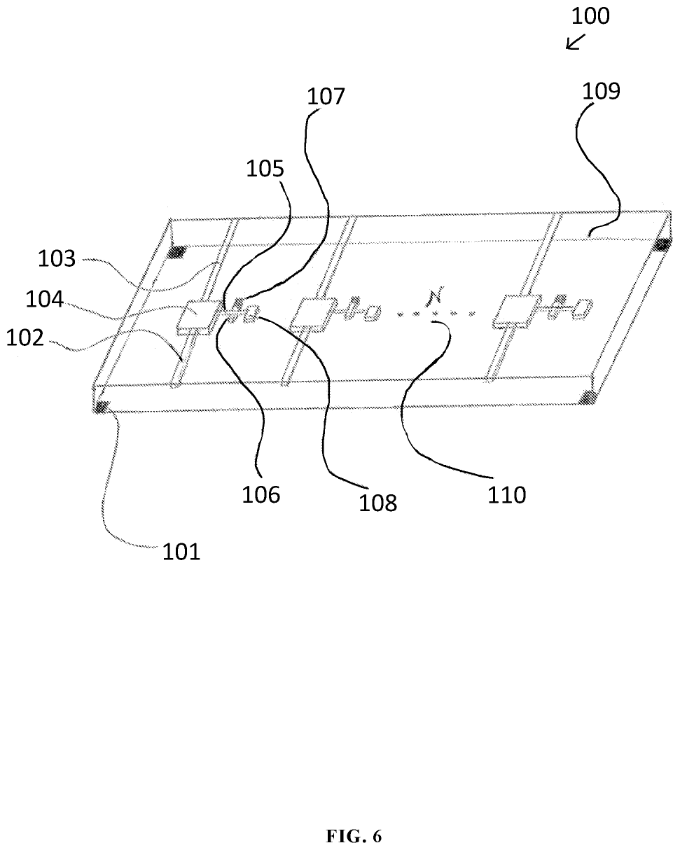

FIG. 6 embodies a simple and general representation of a microfluidic chip 100. In this embodiment the microfluidic chip 100 has total lateral dimensions in the mm range. This is particularly useful for handheld tests. In some other embodiments, the microfluidic chip 100 may have lateral dimensions different from the mm range, for example in the cm range. The microfluidic chip 100 shown could be constructed in multiple ways out of multiple materials and/or a combination of multiple materials. For example, the microfluidic chip 100 could be constructed out of a solid material, including semiconductors, ceramics, metals and polymers. It could be constructed by subtractive methods, starting with a block of material and using wet or dry chemical or mechanical methods to remove material to form channels, wells and other structures within the material. It could also be constructed using additive methods, where one or several layers of one or several materials are added to a substrate 109 by using gluing, evaporation, sputtering, chemical vapour deposition (CVD) or other types of deposition on the substrate to form the microfluidic chip 100 structures. Alternatively, it could be constructed using forming methods where the chip material is bent or moulded or otherwise altered in shape. Physical force or heating/cooling or other forces might be used to achieve this. Some materials with the property of changing their physical structure over time and/or when mixed/exposed to another material might also be used to achieve this. An example of this would be epoxy resin, which solidifies when mixed to certain epoxy hardeners. A mould might be used and the material might also be transformed into a liquid state and then allowed to cool in order to effect this moulding process. The mould can then be physically separated from the microfluidic chip 100 in multiple ways. Some ways will preserve the shape of both the mould and the microfluidic chip 100. An example would be the ‘peel-off’ method. Some other ways will preserve the shape of the microfluidic chip 100 but not that of the mould. An example would be dissolving the mould by immersing it into a chemical solution. The first method is usually preferred as it allows utilising the mould many times for fabricating many chips thereby decreasing fabrication costs. A combination of these methods and other methods might also be used to construct the microfluidic chip 100. Some examples of common methods employed to construct the microfluidic chip 100 shown in FIG. 6 include: (1) lithography on a silicon or other semiconductor (or alternative material) hard substrate, where certain polymers are added through spinning or other methods onto the material followed by exposure to light of a known intensity and wavelength or other radiation through a specially designed mask. The exposed polymer is then removed (or alternatively the non-exposed polymer is removed) and sputtering or evaporation or other additive methods are then used to deposit material onto the substrate or etching methods are used to remove substrate material where there is no polymer. The remaining polymer is subsequently removed leaving additional parts (or removed material) only where there was no polymer. Successive lithography and addition/subtraction steps can be used to build up the microfluidic chip 100 structures. (2) Where the microfluidic chip 100 substrate is a polymer this is heated to make the polymer soft then pressed into a mould constructed of a hard material and allowed to cool so the polymer sets into the required chip design. The mould is then removed. (3) The microfluidic chip 100 substrate can be made of a material that changes its physical structure over time and/or when exposed to a different material and/or the temperature changes. This material can be initially in fluid form, and is then poured into a mould constructed of a hard or soft or flexible material and allowed to solidify by exposing the fluid to a different material and/or a change of temperature. The mould is then removed. The material utilised to construct the microfluidic chip 100 could be mixed, whilst in fluid form, with any other material in liquid and powder form to change the physical properties of the resulting chip material, if needed. (4) The microfluidic chip 100 substrate can be shaped directly by other mechanical and optical methods, for example by means of laser-micromachining whereby a high-intensity laser is directed into a substrate made of polymer, metal, glass, silicon, ceramic, composites or other materials; being able to machine the substrate to the required shape with extremely high resolution. This or similar methods can also be used to machine a suitable mould for (2) and (3).

Many of the above described methods of construction of the microfluidic chip 100 are batch construction methods so the same or similar patterns may be repeated across the microfluidic chip 100 and all such structures can be fabricated through the same (or almost same) number of steps as it takes to allow construction of one set of chip structures. This allows the microfluidic chip 100 to be produced containing complex structures for quantification of multiple target agents and the production of such the microfluidic chip 100 to be of similar complexity as that for production of the microfluidic chip 100 containing one set of structures for quantification of one target agent only.

Other embodiments of the microfluidic chip 100 could have different chip shape and layout of components on the microfluidic chip 100 and function exactly or similarly to this particular embodiment. In this particular embodiment there are magnetic points 101 on the microfluidic chip 100 to help it align correctly when placed into a device in order to have proper function of the microfluidic chip within the device. However other embodiments of the microfluidic chip 100 could instead contain clips, slots or other mechanical methods of alignment or electrostatic or electromagnetic methods of alignment or any other form of alignment mechanism previously detailed in standard devices without affecting functionality and all of these are embodiments of the present disclosure.

The different structures of the microfluidic chip 100 including various channels and wells could also be coated with various materials. Coating might be by evaporation or sputtering or other additive methods during construction of the microfluidic chip 100. Alternatively, one or more fluids might be passed through the channel or well to deposit the coating. The coating might carry out different functions, for example it might be hydrophobic or charged to prevent sticking of target agents, dust or other structures in the fluids passing through or next to various chip structures to the various surfaces of these chip structures. Alternatively, the surfaces of the microfluidic chip 100 structure might be hydrophilic so that certain target agents adhere to them. Different chip structures or parts of structures might be constructed or coated so as to be hydrophobic, hydrophilic, charged or have other properties as required for chip function.

The microfluidic chip 100 has various channels for conducting the fluid containing at least one target agent and any reagents and other fluids required to be added for the present disclosure to achieve its function to quantify the at least one target agent. The fluid or fluids containing the at least one target agent might be transported as a continuous flow or might be transported as micro droplets within a carrier fluid or there might be any other method of transport of the fluid/s through the chip; by “microfluidic” all that is meant is that dimensions of structures through which the fluid is transported on the chip are usually less than 1 mm, this designation does not refer to any particular method of fluid transport. 102 shows an input channel. The input channel 102 could be of various shapes, and the dimensions as shown in this embodiment are in the micrometre range but in other embodiments these could be in the nanometre range or larger or smaller to be contiguous with the chip format and dimensions. Furthermore, the direction of and path of the input channel 102 relative to the chip could also be many other topographies without affecting function. The input channel 102 is the entry point for at least one fluid containing at least one target agent to be quantified. One example of fluids could be water from a reservoir which is being tested for one or more target agents to determine cleanliness. Alternatively, for example it could be serum derived from the blood of a patient which is being tested for various target agents in the blood, for example protein biomarkers. The fluid might enter into the input channel 102 through various methods, for example, a well feeding into the input channel 102 in which the fluid can be placed from a syringe or a “pinprick” device attached to the front of the input channel 102 which penetrates the skin of a patient in order to draw blood directly. The blood in that case either directly enters into the input channel or is filtered or otherwise processed so that derived serum, plasma or other component of the whole blood enters into the input channel. Note that there is not necessarily a requirement to quantify the amount of fluid being entered into the input channel 102.

103 shows an output channel. The output channel 103 could be of various shapes, and the dimensions as shown in this embodiment are in the micrometre range but in other embodiments these could be larger or smaller to be contiguous with the chip format and dimensions.

Furthermore, the direction of and path of the output channel 103 relative to the chip could also be many other topographies without affecting function. The output channel 103 could be constructed or coated in such a way, for example hydrophobic coating, so as to cause fluid to be eluted from the output channel 103, alternatively certain fields or forces, such as electrostatic forces or charging or mechanic forces could be used to cause fluid to be eluted actively when required for operation. Similar methods and also physical blocking of the output channel 103 could be employed to prevent elution of fluid from the output channel 103 when required.

104 shows a capture well. The microfluidic chip 100 contains at least one capture well 104 which may be embodied in various dimensions and topographies. Its structure is that of a small chamber. In addition to any other coating this particular structure contains at least one capture agent which is placed into the capture well 104 during construction of the capture well 104. The capture agent might be placed into the capture well 104 through manual methods, including drop coating. Alternatively, it might be coated onto the surface of the capture well 104 using methods whereby a tip is dipped into a fluid or a fluid is run onto a tip and then the tip is applied to the surface or it might be printed onto the surface using inkjet printing methods or methods similar to inkjet methods or other methods whereby the capture agent is sprayed onto the surface or the capture agent might be applied in many other commonly known ways described in the art. It might be applied in a solid form or applied carried in a fluid or aerosol. In the latter cases it might dry to form a spot or layer in the capture well 104.

In this embodiment, the capture well 104 is being fed from only one input channel 102. In other possible embodiments, the capture well 104 may be fed from two or more input channels 102. Each input channel 102 is the entry point of at least one fluid. In one embodiment several fluids may be input into the capture well 104 though only one input channel 102. In another embodiment several fluids may be input into the capture well 104 though two or more input channels 102. In another embodiment several fluids may be input into the capture well 104 though only one input channel 102.

In this embodiment, the capture well 104 has only one output channel 103. In other possible embodiments, the capture well 104 may feed into two or more output channels 103. Each output channel 103 is the exit point of at least one excess or waste fluid. In one embodiment several fluids may be output from the capture well 104 though only one output channel 103. In another embodiment several fluids may be output from the capture well 104 though two or more output channels 103. In another embodiment several fluids may be output from the capture well 104 though only one output channel 103.

In these embodiments, but not all embodiments, there is a connecting channel 105 between the capture well 104 and a detection well 108. In other embodiments there may be zero, one or many of these connecting channels 108. In general, there may be additions or subtractions of channels from the chip relative to the design embodied here as long as the fluid is still able to flow into and out of the microfluidic chip 100 and be exposed to the detection and capture agents in correct sequence.

The microfluidic chip 100 contains at least one detection well 108 which may be embodied in various dimensions and topographies. Its structure is that of a small chamber.

In addition to any other coating this particular structure contains at least one detection agent which is placed into the detection well 108 during construction of the detection well 108. The detection agent might be placed into the well through manual methods, including drop coating. Alternatively, it might be coated onto the detection well 108 surface using methods whereby where a tip is dipped into a fluid or a fluid is run onto a tip and then the tip is applied to the surface or it might be printed onto the surface using inkjet printing methods or methods similar to inkjet methods or other methods whereby the detection agent is sprayed onto the surface or the detection agent might be applied in many other commonly known ways described in the art. It might be applied in a solid form or applied carried in a fluid or aerosol. In the latter cases it might dry to form a spot or layer in the detection well 108.

In this embodiment, the detection well 108 is not being fed from any input channel 102. In other possible embodiments, the detection well 108 may be fed from one input channels 102. In other possible embodiments, the detection well 108 may be fed from two or more input channels 102. Each input channel 102 is the entry point of at least one fluid. In one embodiment several fluids may be input into the detection well 108 though only one input channel 102. In another embodiment several fluids may be input into the detection well 108 though two or more input channels 102. In another embodiment several fluids may be input into the detection well 108 though only one input channel 102.

In this embodiment, the detection well 108 has zero output channels 103. In other possible embodiments, the detection well 108 may feed into one output channels. In other possible embodiments, the detection well 108 may feed into two or more output channels 103. Each output channel 103 is the exit point of at least one excess or waste fluid. In one embodiment several fluids may be output from the detection well 108 through only one output channel. In another embodiment several fluids may be output from the detection well 108 through two or more output channels 103. In another embodiment several fluids may be output from the detection well 108 through only one output channel 103.

107 shows a blocking agent. The blocking agent 107 could be of various shapes, and the dimensions as shown in this embodiment are in the micrometre range but in other embodiments these could be larger or smaller to be contiguous with the channels shape and dimensions. The purpose of the blocking agent 107 is that when it is placed between the capture well 104 and the detection well 108 it inhibits passage of fluid between these two wells. When it is removed from between these two wells fluid can pass between these two wells. In this embodiment the blocking agent 107 is a physical object. It could be constructed in different shapes, but in this embodiment is cuboid in shape. The blocking agent 107 could also be constructed out of any material. In this embodiment it is constructed out of a magnetic metal such as nickel. The blocking agent 107 could be coated or uncoated with various coatings or multiple coatings in order to enable it to carry out its function better. In this embodiment, the blocking agent 107 is coated with a polymer which prevents leaching of the metal ions into any fluid running through the chip and also to reduce friction and damage to the channels or wells when the blocking agent moves. The polymer is also hydrophobic to inhibit any fluid from passing around the blocking agent so that the blocking agent is better at carrying out its function. The blocking agent 107 could be moved using mechanical force, magnetic force, electrostatic force or any other force utilised at the macroscopic, microscopic or smaller scale for moving objects. In this embodiment, the blocking agent 107 is moved using magnetic force generated through electromagnetism. The blocking agent 107 could be passively or actively controlled. In this embodiment the electromagnetism and therefore moving of the blocking agent 107 is actively controlled. Alternatively, to the moving blocking agent 107 shown in this embodiment, various other ways to block fluid flow could be employed, for example valves or gates. Alternatively, the blocking agent 107 could be non-physical, for example electrostatic forces or hydrophobic or hydrophilic forces could be used to prevent or enable fluid flow as required. Any other method of blocking fluid flow publically known could be employed.

In this embodiment the blocking agent 107 is contained within a blocking channel 106 perpendicular to and intersecting the connecting channel 105 between the capture well 104 and the detection well 108. This allows the blocking agent 107 to be moved into position at the junction of the blocking channel 106 and the connecting channel 105 to block fluid flow between the capture well 104 and the detection well 108 when required and to be moved into a different position within the blocking channel 106 so as not to be blocking the connecting channel 105 when required to enable fluid flow. In some embodiments there will also be a blocking agent 107 between the input channel 102 and the capture well 104 or a blocking agent 107 between the capture well 104 and the output channel 103 or there may be blocking agents 107 at other points on the microfluidic chip 100 or between structures not shown in the embodiment. The blocking agent 107 may operate on the same or different principles. The blocking agent 107 in all embodiments enable control of the fluid flow throughout the chip and therefore enable control of the detection and capture agents, since the exposure of the fluid containing the at least one target agent to each capture or each detection agent is controlled. In certain embodiments the blocking agent 107 will also enable the amount of the fluid containing at least one target agent that is exposed to a particular capture agent or a particular detection agent to be controlled since they will be able to block a subset of the fluid into a particular well or other chip structure for a certain controlled period of time. Similarly, they will be able to block other fluids containing other reagents into a particular well or other chip structure for a controlled period of time.

In alternative embodiments the detection agents could be sprayed into the capture chamber or each agent could be individually moved or controlled to move around the microfluidic chip 100 either in solid form or carried in a liquid or other vector. Each of these and other examples are embodiments of the principle of the present disclosure whereby the exposure of the fluid containing the at least one target agent to each at least one capture and each at least one detection agent is individually controlled.

In this embodiment fluid containing the at least one target agent is flowed into the input channel 101 and from there into the capture well 104. In the capture well 104 at least one capture agent captures at least one target agent. In this embodiment the capture well 104 is constructed so that any capture agent remains attached to the surface of the capture well 104 even as any capture agent captures any target agent. Furthermore, any part of the capture well 104 not containing capture agent is constructed so as to prevent adhering of the target agent or any other material flowing through the capture well 104 to the surface of the capture well 104. At this first step the blocking agent is blocking the connecting channel 105, preventing fluid from flowing into the detection chamber. In the second step, a standard washing fluid used in biological processes is washed through the capture well 104 to wash away the fluid containing the at least one target agent and any unbound target agent. In the third step the blocking agent 107 is removed from the connecting channel 105 into a different section of the blocking channel 106. Therefore, fluid flows into the detection well 108. This causes the at least one detection agent in this well to mix with the fluid and the detection agent will then pass through into the capture well 104 and react with at least one target agent bound to at least one capture agent in the capture well 104. In certain embodiments when there are also other blocking agents at entrance or exit to the capture well 104 or other points these can be used to ensure that the detection agent is exposed in a particular concentration for a chosen time to the captured target agent in the capture well 104. In the fourth step washing fluid is flowed through to wash out any unbound detection agent. In the fifth step the presence of the at least one captured target agent is determined or alternatively the presence of the at least one captured target agent is determined and the amount of the captured at least one target agent is quantified (see below).

In an alternative embodiment, there are intermediate steps between the fourth and fifth steps described above whereby a further fluid containing at least one reagent is flowed through the microfluidic chip 100 and this reagent may bind to or otherwise react with the capture agent, the target agent or the detection agent or another reagent involved in the operation of the disclosure described herein. A further washing step is then carried out to remove any unbound or otherwise unreacted or unneeded component. In a further alternative embodiment, there may be multiple steps flowing reagents through the microfluidic chip 100 and/or multiple washing steps.

In a further alternative embodiment, instead of the at least one other reagent being flowed onto the microfluidic chip 100 it is contained within another part of the microfluidic chip 100. In another embodiment, it is contained in another part of the microfluidic chip 100 and there is a blocking agent 107 preventing it reacting with capture agent, target agent or detection agent until the blocking agent 107 is removed. Again in other embodiments there may be multiple reagents on the microfluidic chip 100.

In other embodiments, these steps are carried out in a different order and there may be additional or fewer or different steps with additional reagents also residing on the microfluidic chip 100 or flowed onto and through the microfluidic chip 100 as required. For example, in another embodiment, the detection agent might be mixed with the fluid containing the at least one target agent. In other embodiments, reagents might be mixed.

In various other embodiments the shape, dimensions and connection between the various components of the microfluidic chip 100 as set out in these embodiments will be different. Additional reagents might also be required and could be contained on the microfluidic chip 100 or flowed onto the microfluidic chip 100 or a combination of these.

In some embodiments, the microfluidic chip 100 will also contain sensing structures to form part of the quantification system for the bound target agent. These sensing structures are preferably, but not necessarily, located into the capture well 104 or right under and/or above the capture well 104. This allows immediate quantification of the target agent as it is captured without the need of further processing. Embodiments of such sensing structures include (but are not limited to):

(1). Oscillating sensors, which are structures on the chip which are caused to oscillate. The oscillation frequency of the structure depends on mass so it changes according to quantity of any material which attaches to the oscillating sensor and this change in oscillation is related to the concentration of the target agent. Examples of these sensors include miniature quartz crystal microbalances (QCM) and surface acoustic wave (SAW) structures;

(2). Electrochemical sensors whereby reaction with an agent in the fluid produces an electrical signal related to the target agent concentration. A typical electrochemical sensor consists of a sensing electrode and a counter electrode separated by a thin layer of an insulating material. Examples of these sensors include potentiometric biosensors;

(3). Electronic sensors, whereby the interaction of an agent with some components of the sensor produces a change in the electrical properties of these parts of the sensor, whereby the change in these properties related to the target agent concentration. Examples of these sensors include field-effect transistors (FETs) whereby binding of an agent to the gate of the FET changes the resistance between the source and the drain of the FET;

(4). Hall effect sensors, which are transducers that vary their output voltage in response to a magnetic field. The output voltage variation is related to the target agent concentration;

(5). Optical sensors, whereby light absorption or emission related to the concentration of the target agent occurs. This light absorption can be due, for example, to a colour change in the substrate due to a chemical reaction of an agent with other reagents such as enzymes, which could be measured by, for example, spectrophotometry; or to the direct absorption or emission of light of particular wavelength or wavelengths due to the optical properties of the agent, or due to the agent having a fluorescent or luminescent structure attached. Examples of these sensors include the enzyme-linked immunosorbent assay (ELISA) and photoluminescent sensors;

(6). Optical sensors utilising alternative methods of optical detection whereby variation in the optical signal is related to the concentration of the target agent. Examples of such optical detection systems include interferometry or near-field microscopy (measurement of variation in the evanescent wave); and

(7). Mechanical sensors, whereby a deformation in the physical shape of the sensors due to the additional stress introduced by adherence of an agent is induced. This deformation, which is related to the target agent concentration, could be detected by for example optical interferometry or a change in electrical, mechanical, magnetic or structural properties of the material. Examples of these sensors include cantilever-based sensors and piezoelectric sensors.

For completeness, some examples of fluids containing target agents include: (1). Any solution or suspension used for commercial or non-commercial applications containing a particular inorganic chemical to be quantified, for example for the chemical industry; (2). Any solution or suspension used for commercial or non-commercial applications containing a particular organic chemical; (3). Any biological fluid; (4). Any fluid from human or animals, but particularly blood, urine, mucus, saliva and cerebrospinal fluid; (5). Any fluid from other biological organisms, including plants, fungi, bacteria or archaebacteria; (6). Any fluids from any other biological entity; (7). Fluids containing products from the food industry; and (8). Water from rivers, the sea, rain, waste water plants or other sources.

For completeness, some examples of target agents include: (1). Proteins (both natural and synthetic), including antibodies, antigens, enzymes, and other proteins; or structures comprising proteins; (2). Peptides (both natural and synthetic); (3). Amino acids or structures comprising amino acids (both natural and synthetic); (4). DNA (both natural and synthetic); (5). RNA (both natural and synthetic); (6). Nucleic acids or structures comprising nucleic acids (both natural and synthetic); (7). Saccharides or structures comprising saccharides (both natural and synthetic); (8). Lipids or structures comprising lipids (both natural and synthetic); (9). Other biomolecules and structures comprising biomolecules (both natural and synthetic); (10). Whole cells or part of cells or groups of cells (with or without inclusion of non-cell structures); (11). Any structures comprising cells; (12). Any other biological structure; and (13). Any non-biological chemical structure which has specific patterns that can be recognised by a capture agent and used to bind and immobilise the target agent.

For completeness, some examples of capture agents include: (1). Antibodies produced using any means whatsoever including monoclonal antibodies, polyclonal antibodies or antibodies produced through purely chemical synthesis; (2). Aptamers, both naturally occurring, produced using biological methods or produced using synthetic chemical methods or any other natural or synthetic methods; (3). Nucleic acid strands or structures (both natural and synthetic); (4). Peptide strands or structures (both natural and synthetic); (5). Molecules or other chemicals incorporating patterns of charge complementary to charged patterns on target agents; (6). Molecules or other chemicals incorporating patterns of hydrophobic or hydrophilic regions complementary to patterns on target agents; (7). Molecules or other chemicals incorporating patterns of dipoles, quadrupoles, or other higher order poles complementary to such patterns on target agents; (8). Molecules or other chemicals incorporating patterns of magnetic regions complementary to magnetic patterns on target agents; (9). Inorganic materials either naturally occurring or prepared using any synthetic strategies or otherwise. Example of such inorganic structures include functionalised carbon nanotubes, both single wall and multiwall, silicon polymers (for example with specific charge patterns) and nanoparticle complexes; and (10). Structures (including cells, tissues and other organic and inorganic structures) incorporating any of the above as substructures, components or elements.

For completeness, some examples of detection agents include: (1). Antibodies produced using any means whatsoever including monoclonal antibodies, polyclonal antibodies, antibodies produced through purely chemical synthesis; (2).

Aptamers, both naturally occurring, produced using biological methods or produced using synthetic chemical methods or any other natural or synthetic methods; (3). Nucleic acid double and single strands or structures (both natural and synthetic); (4). Peptide strands or structures (both natural and synthetic); (5). Molecules or other chemicals incorporating patterns of charge complementary to charged patterns on target agents; (6). Molecules or other chemicals incorporating patterns of hydrophobic or hydrophilic regions complementary to patterns on target agents; (7). Molecules or other chemicals incorporating patterns of hydrophobic or hydrophilic regions complementary to patterns on target agents; (8). Molecules or other chemicals incorporating patterns of dipoles, quadrupoles, or other higher order poles complementary to such patterns on target agents; (9). Molecules or other chemicals incorporating patterns of magnetic regions complementary to magnetic patterns on target agents; (10). Inorganic materials either naturally occurring or prepared using any synthetic strategies or otherwise. Example of such inorganic structures include functionalised carbon nanotubes, both single-wall and multi-wall, silicon polymers (for example with specific charge patterns) and nanoparticle complexes; and (11.) Structures (including cells, tissues and other organic and inorganic structures) incorporating any of the above as substructures, components or elements.

Examples of other reagents include secondary antibodies which aid in the detection of target agents by binding to the detection antibody (or other reagent), which binds to the target agent. Either the detection antibodies or a secondary antibody might have a bound enzyme to cause colour change of a reagent “developer” similar to a standard ELISA process or they might have a fluorescent or electrochemiluminescent region or other region relevant to the chosen detection mechanism. There might also be multiple enzymes attaching to a single detection antibody or secondary antibody. Methods for them to bind include those commonly seen in the art such as streptavidin-biotin binding. Other reagents might be particles, including nanoparticles, which bind to the target agent or the detection agent. In one embodiment such nanoparticles are used to increase the mass bound to a mass sensor by a set amount per bound target agent in order to enhance the sensitivity of a mass sensor (such as the oscillating sensor or mechanical sensor systems described above). In a different embodiment magnetic nanoparticles are used to increase the output voltage change per unit of magnetic field in Hall effect sensors. Other reagents may be organic and inorganic chemicals that bind to the target agent. In one embodiment such chemicals bind to the target agent and promote the oxidation of a metallic thin film producing an enhanced change in the electrical signal detected in electronic sensors.

The microfluidic chip 100 is formed by ‘N’ sensing structures with their corresponding wells and channels necessary for target agent quantification; i.e. the system is formed by ‘N’ quantification systems. This is indicated by one or more quantification systems 110 in FIG. 6. ‘N’ can be any number between 1 and infinity; i.e. the chip may be composed of any number of a quantification system 110. For example, the chip may be composed of one quantification system 110. In another example, the chip may be formed of ten quantification systems 110. In another example the sensor may be formed of one hundred quantification systems 110. All sensing structures and quantification systems 110 are preferably identical. For example, in one embodiment all quantification systems 110 comprise sensing structures which are oscillating structures. For example, in a different embodiment all quantification systems 110 comprise sensing structures which are a type of electrochemical sensors. In some embodiments however, the quantification system 110 may be different. In an example of such an embodiment half of the quantification systems 110 comprise sensing structures which may be oscillating structures and the other half of the quantification systems 110 comprise sensing structures which may be a type of optical sensor. In a different example of such embodiment half of the quantification systems 110 comprise sensing structures which may be oscillating structures and the other half of the quantification systems 110 comprise sensing structures which may be a type of electrochemical sensor. Each quantification system 110 is used for the quantification of one different target agent. In some embodiments two or more quantification systems 110 may be used for the quantification of the same target agent for comparison, however the measurements taken by the quantification system 110 are independent from each other; i.e. the use of several quantification systems within a chip to quantify the same target agent adds confidence to the results by repeatability but does not add additional sensitivity nor is such needed.

In various other embodiments, the locations of the quantification system 110 within the microfluidic chip 100 are different to those shown in FIG. 6. For example, in one embodiment the plurality of a quantification system 110 may be placed one next to each other in one linear direction, forming a linear array of the quantification system 110. In another embodiment, the one or more quantification system 110 may be placed one next to each other following two linear directions, forming a two- dimensional array. For example, in another embodiment the quantification systems 110 may be placed in random discrete positions within the chip.

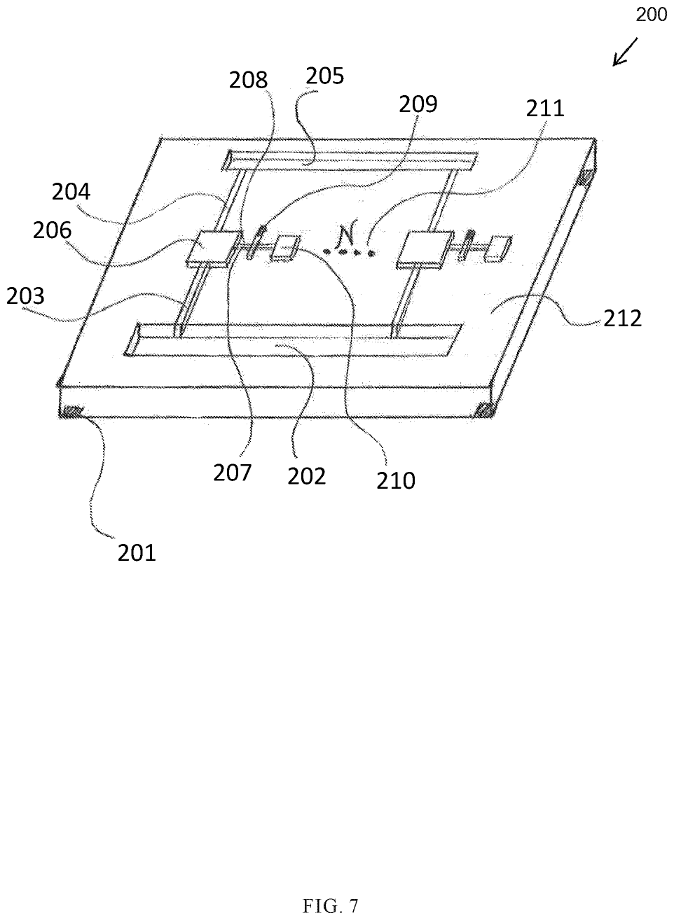

FIG. 7 shows a microfluidic chip 200 which is substantially similar to the microfluidic chip 100 shown in FIG. 6. The microfluidic chip 200 further includes an input well 202 feeding into an input channel 203. The input well 202 could be of various shapes, and the dimensions as shown in this embodiment are in the mm range but in other embodiments these could be in the cm range or 100 μm range or larger or smaller to be contiguous with the chip format and dimensions. The fluid can be placed into the input well from a syringe or a “pinprick” device attached to the front of the input channel 203 which penetrates the skin of a patient in order to draw blood directly. In this embodiment there is only one input well 202 that feeds directly into all the input channels 203 with no additional microfluidic control. However, in some embodiments, there may be more than one input well 202 feeding selectively into at least one input channel 203. For example, in one such embodiment there is one input well 202 feeding all input channels 203. For example, in a different embodiment there are two input wells 202 feeding each half of the input channels 203. In a third different example of such embodiment, there are two input wells 202 feeding alternatively all the input channels 203. The embodiment shown in FIG. 7 also contains an output ‘waste’ well 205, being fed from an output channel 204. The output well 205 collects excess or waste fluid generated during the quantification process. Preferably there is only one output well 205 containing all excess and waste fluid generated. In a less preferred embodiment, the microfluidic chip 200 may contain more than one output well 205. In the embodiment shown in FIG. 7 there is only one output well 205 that is fed directly from all the output channels 204 with no additional microfluidic control. However, in some embodiments of the present disclosure, there may be more than one output well 205 being fed selectively from at least one output channel 204. The microfluidic chip 200 could be designed in many different ways using any combination number of the input wells 202 and the output well 205.

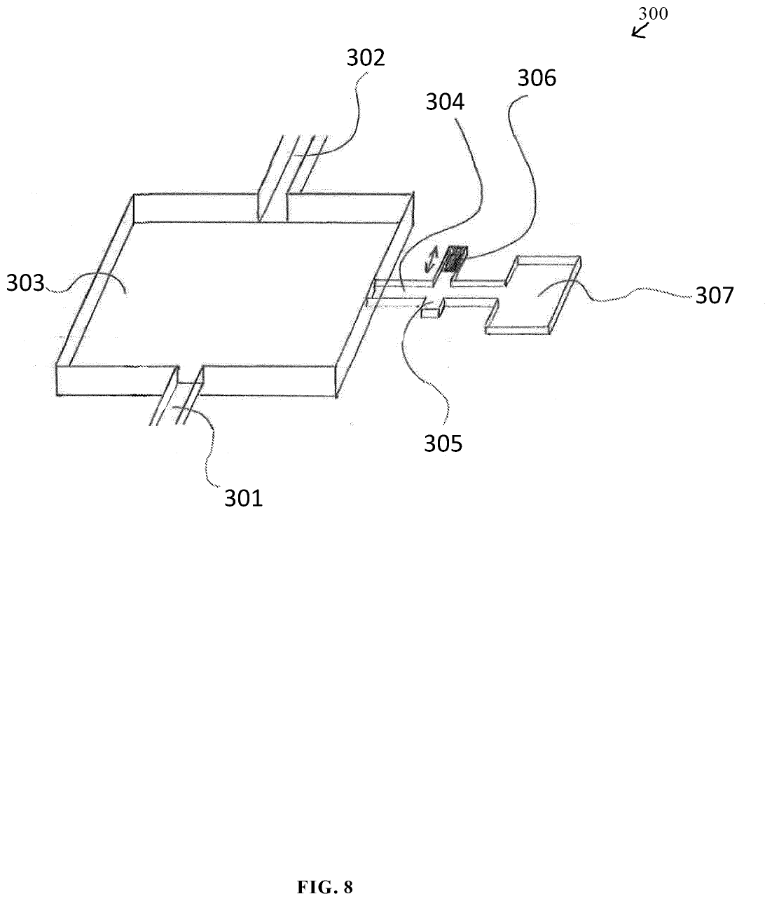

FIG. 8 shows a detailed view of a section of a quantification system 300 as shown in FIG. 6 according to an embodiment of the present disclosure. What is shown is an input channel 301 which corresponds to the input channel 102; an output channel 302 corresponding to the output channel 103; a capture well 303 corresponding to the capture well 104; a connecting channel 304 corresponding to the connecting channel 105; a blocking channel 305 corresponding to the blocking channel 106; a blocking agent 306 corresponding to the blocking agent 107; and a detection well 307 corresponding to the detection well 108.

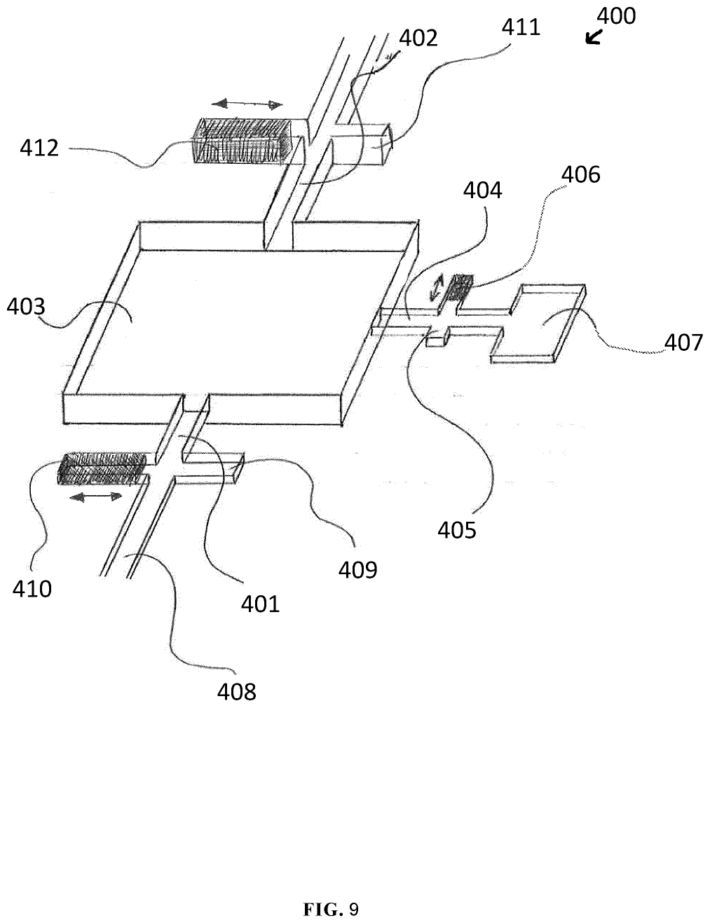

FIG. 9 shows an alternative embodiment for a quantification system 400 in which there is a blocking agent 410 between an input channel 408 and a capture well 403 and a blocking agent 412 between a capture well 403 and an output channel 402, as well as a blocking agent 406 between the capture well 403 and a detection well 407. The blocking agents 406, 410 and 412 may operate controllably on the same or different principles. Also shown is an input channel 401 between the input channel 408 and the capture well 403, a connecting channel 404 located between the detection well 407 and the capture well 403, and blocking channels 409 and 411 that are associated with the blocking agents 410 and 412 respectively.

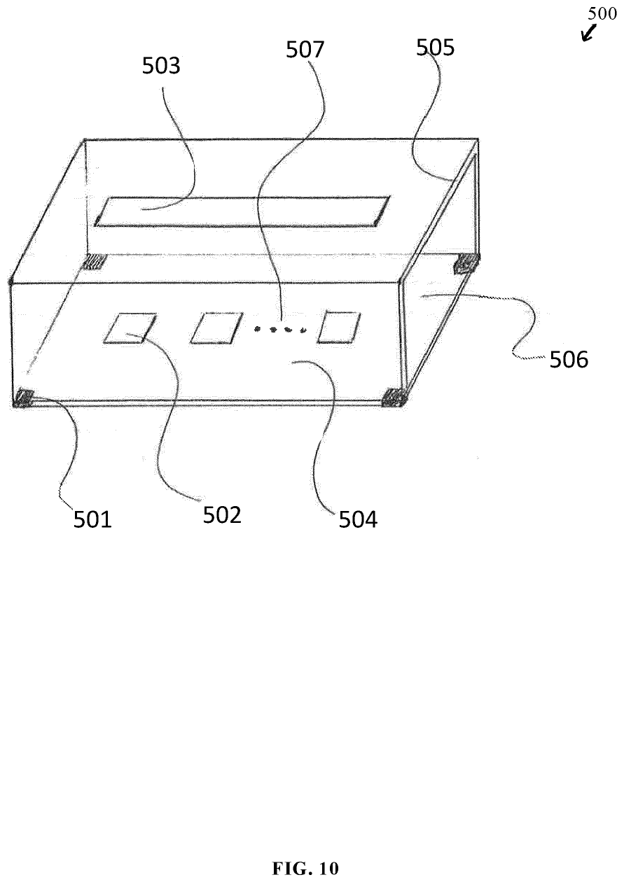

FIG. 10 embodies a loading device 500 into which the microfluidic chip 100, 200 as hereinbefore described, slots into for the determination of the presence of, or the quantification of, the at least one target agent. The loading device 500 is suitable to control the flow and mixture of fluids within the microfluidic chip 100, 200 and suitable to control a sensor. In this embodiment the loading device 500 has total lateral dimensions in the cm range. This is particularly useful for handheld tests. In some other embodiments the loading device 500 may have lateral dimensions different from the cm range, for example in the dm range. This is more suitable for benchtop tests. In this embodiment there is a positioning mechanism 501 for ensuring that the microfluidic chip 100, 200, when placed on or in the loading device 500, slots into the correct position on the device. This mechanism could be purely mechanical or use many different methods of operation which are standardly and publically known. In this particular embodiment there are magnetic points which correspond to magnetic points on the microfluidic chip 100, 200, shown as 101 in FIG. 6, and therefore attract the corresponding points on the microfluidic chip, ensuring that the microfluidic chip slots into place correctly on the device. In this particular embodiment there are also connecting electronics 502 which connect any electronic connections or structures on the microfluidic chip, for example any electronically operated sensing elements, to the control electronics in the device. Depending on the sensing system used to detect presence of or quantify the amount of at least one target agent there may be a detector 503 in the device. This will include a sensing element and any other structures required for detection to operate. For example, in one embodiment where detection operates similar to an ELISA system whereby colour change or fluorescence in certain parts of the microfluidic chip are detected or measured, then the detector consists of a light producing element which illuminates the chip and a light sensing system which can measure the change in the light because of absorption or emission in the microfluidic chip. In one embodiment of this system, there is also a control mechanism between the light producing element that controls exposure and non-exposure of different regions of the microfluidic chip 100, 200 to the light from a light producing element and allows different regions of the microfluidic chip to be exposed, not exposed or have different levels of exposure to the light from the light producing element at different time periods. In one embodiment this control mechanism is a liquid crystal panel similar to that used in a liquid crystal display. In another embodiment there are multiple light producing elements. In a further embodiment there are multiple light producing elements and each light producing element exposes only a particular region of the microfluidic chip. In another embodiment this exposure of different parts of the microfluidic chip by individual light elements is done by an LED panel similarly to that operating in an LED television display.

In the embodiment shown in FIG. 10 there is also an embedded processing unit/electronics 504. This consists of a standard at least one microcontroller or at least one microprocessors, memory and other such standard electronics known to be used for the purpose of processing data from any sensing components on the device, control of active components, if any, on the device and any other functions of the device if required. In this embodiment there is one processing unit. In alternative embodiments there may be multiple processing units.

This embodiment of the device includes a housing 505, which is a standard enclosure enclosing the electronics and the microfluidic chip and may also prevent contamination of the inside of the device by physical particles, light or other unwanted externals. In this embodiment there is also an insertion slot 506 through which a microfluidic chip is placed into the loading device 500. There may be other standard electronics or connections 507 on the device to allow for its normal or enhanced operation.

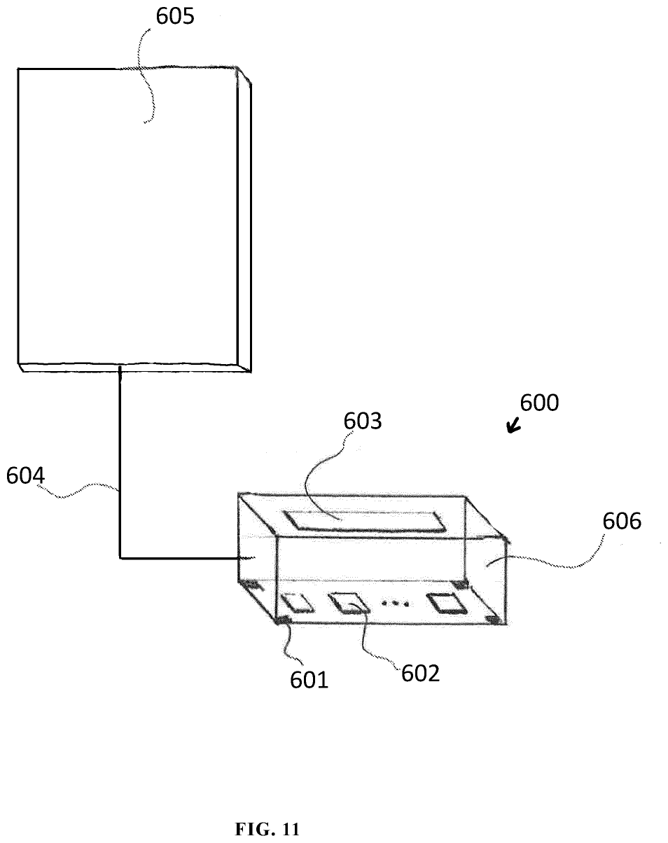

FIG. 11. shows an alternative embodiment in which a loading device 600 into which a microfluidic chip slots into for the quantification of the target agent has no onboard processing unit, but the device is connected through a wired connection 604 to a separate at least one smart structure 605 such as, but not limited to, a computer, a laptop, a tablet device, a mobile phone or a custom-made infrastructure, where processing takes place. The wired connection 604 is preferably made through a USB/miniUSB/microUSB cable. Alternatively, the wired connection 604 is made through a RS232, GPIB or a different type of data cable. The smart structure 605 is preferably connected to the internet through a mobile network connection or through Wi-Fi. In an alternative embodiment the loading device 600 is connected wirelessly to at least one smart structure 605 (where processing takes place) through Bluetooth or Wi-Fi or alternative wireless data connection. In an alternative embodiment the loading device 600 is connected via the internet or other network to a separate at least one smart structure where processing takes place.

Any combination of standard onboard and offboard electronics for data acquisition, processing and device control is an embodiment of the present disclosure.

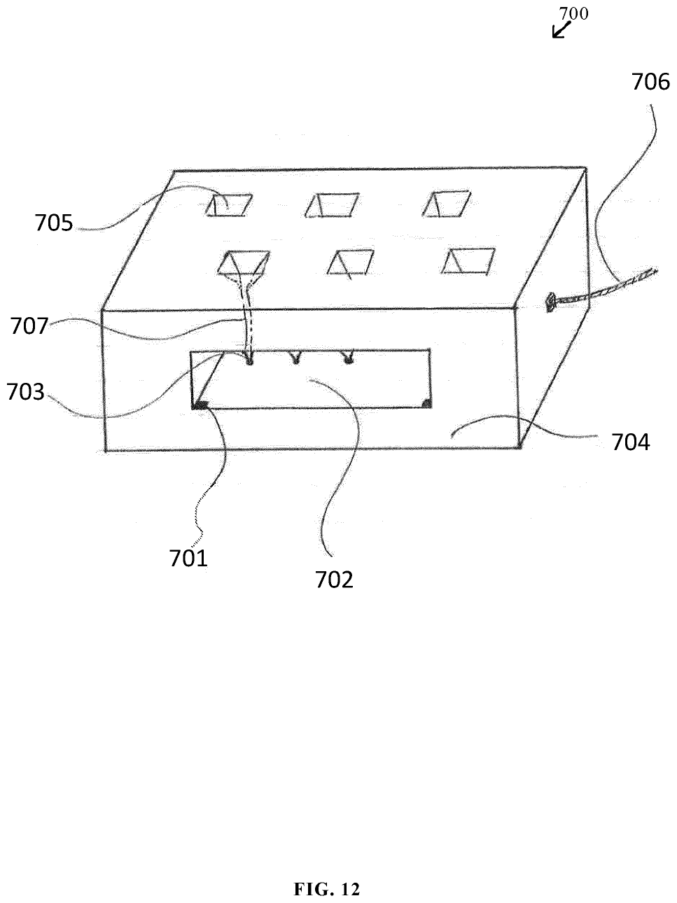

FIG. 12 is an embodiment of a loading machine 700. There is a positioning system on the loading machine to ensure that microfluidic chips are placed in the correct place when loaded onto the loading machine 700. This could operate in many different standard ways, including any publically known. In this embodiment a magnetic point 701 are used which will attract the corresponding magnetic points on a microfluidic chip as shown in 101 in FIG. 6. In this embodiment there is an insertion slot 702 into which the microfluidic chip is placed. In other embodiments the microfluidic chip might simply be placed on top of the loader or the insertion slot might have alternative dimensions or geometry. In further embodiments there might be an automated loader to load the chips from a stack or other collection of chips. In this embodiment there is only one insertion slot into which the microfluidic chips are sequentially placed, one after the other. In other embodiments there might be more than one insertion slots 702 for multiple microfluidic chips to be simultaneously loaded into the different slots. In yet other embodiments there may be one insertion slot 702 into which several microfluidic chips are simultaneously placed. In yet another embodiment there may be more than one insertion slot 702 into which multiple microfluidic chips are simultaneously placed. In this embodiment the various “inks” are placed in a microsized ink well 705 in the loading machine 700. By “ink” here is meant a fluid containing at least one capture or detection agent. The various “inks” might contain different capture or detection agents. In other embodiments of the loading machine 700 there could be other methods to load the “inks” for example in one alternative embodiment they could first be loaded into cartridges which are then placed in the loading machine. In another embodiment the at least one capture agent or at least one detection agent might be placed into the machine in a solid form and the machine might mix it into a fluid internally. These alternative methods for loading the “inks” are all various embodiments of the present disclosure. In this embodiment the “ink” runs through the printing tip 703 which touches the surface or goes close to the surface to deposit the ink in a particular location. The positioning of the at least one tip 703 is set in this embodiment and the microfluidic chips are loaded beneath it for the “ink” to be placed or “printed” on so the tip 703 need only move in the vertical, up-down (z) direction. In an alternative embodiment, the tip 703 can also move horizontally in the plane (x-y) directions so that the printing positions can be altered between runs and even between individual microfluidic chips. In other embodiments the printing mechanism is altered so that instead the ink is sprayed from the tip 703 onto the correct position on the microfluidic chip. In other embodiments the number of tips is not the same as the number of “inks” but instead the same tip has multiple “inks” run through it or the same “ink” runs through multiple tips. In different embodiments the tip 703 may be completely different dimensions or geometries, including just being holes in the wells. In other embodiments, instead of the ink running from the wells into the tips 703, the tips 703 are dipped into the wells so that some ink adheres to them and then this ink is placed on the microfluidic chip. In other embodiments there is no tip 703 but instead some alternative method such as manipulation of electrostatic or electromagnetic fields or hydrophilic or hydrophobic forces is used to move the “ink” from the well or wells to the microfluidic chip. There are also embodiments incorporating various combinations of these alternative embodiments. Any system in which the loading machine contains a method for printing the at least one “ink” onto a specific place on the microfluidic chip is an embodiment of the present disclosure. There may also be other structures that form part of the printing system for movement or conduction of the “ink”—in this embodiment there is a connecting channel 707. There are also onboard electronics 704 and other connections. This consists of a standard at least one microcontroller or at least one microprocessor, memory and other such standard electronics known to be used for the purpose of processing data from any sensing components on the loading machine 700, control of active components on the loading machine and any other functions of the loading machine if required. In this embodiment there is one processing unit. In an alternative embodiment there are multiple processing units. In this embodiment there is a wired connection 706 to a computer. In an alternative embodiment there is no onboard processing unit but the system is connected through a wired connection 706 to a separate at least one device or computer where processing takes place. In an alternative embodiment it is connected wirelessly through Bluetooth or Wi-Fi or alternative wireless connection to a separate at least one device or computer where processing takes place. In an alternative embodiment it is connected via the internet or other network to a separate at least device or computer where processing takes place. Any combination of standard onboard and offboard electronics for data acquisition, processing or loading machine control is an embodiment of the present disclosure.

For illustrative purposes, two example embodiments of the present disclosure will now be described.

In a first example embodiment, a microfluidic chip made of polymer, glass or other transparent material, containing ‘N’ quantification systems are used. All capture wells are coated with at least one capture antibody. In this particular embodiment there are ‘N’ capture wells, one per quantification system. In this particular embodiment each capture well is coated with a different capture antibody. All detection wells are coated with at least one detection antibody. In this particular embodiment there are ‘N’ detection wells, one per quantification system. In this particular embodiment each detection well is coated with a different detection antibody.

In this particular embodiment there is one connecting channel between each pair of capture and detection wells. In this particular embodiment there is one actively controlled blocking agent at each connecting channel. In this particular embodiment all blocking agents are initially blocking the connecting channel. In this particular embodiment there is one input well. In this particular embodiment there is one output well. In this particular embodiment there is one input channel connecting the input well and capture well. In this particular embodiment there is one output channel connecting the capture well and output well. Both the capture and detection wells are coated with capture and detection antibodies using a loading machine. The microfluidic chip is introduced into the device. In this particular embodiment the device has pixelated LED lights under the capture wells. In this particular embodiment the device has a light detector above the capture wells. In this particular embodiment the device has embedded electronics to control the LED lights and detector.

In this particular embodiment the fluidic sample to be analysed, perhaps containing a target antigen is deposited into the input well. The fluidic sample to be analysed flows through the input channel, floods the capture well and exits through the output channel. The target antigen if present in the sample to be analysed, binds specifically to the capture antibody immobilised at the surface of the capture well. Abundant clean fluid, for example buffer, is deposited into the input well, flows through the input channel, floods the capture well and exist through the output channel, cleaning loose agents deposited onto the surface of the capture well. The blocking agents are now switched to unblock the connecting channel. A known amount of carrier fluid is deposited into the input well. The carrier fluid flows through the input channel, floods the capture well, flows through the connecting channel and floods the detection well. The detection antibody is transported through the fluid by diffusion and binds to the target antigen, if present, which was immobilised at the surface of the capture well. Abundant clean fluid, for example buffer, is deposited into the input well, flows through the input channel, floods the capture well and exist through the output channel, cleaning loose agents deposited onto the surface of the capture well. Fluid containing enzyme-linked secondary antibody is deposited into the input well, flows through the input channel, flows through the capture well and exist through the output channel. Enzyme-linked secondary antibodies bind to the detection antibody, if present. Abundant clean fluid, for example buffer, is deposited into the input well, flows through the input channel, floods the capture well and exist through the output channel, cleaning loose agents deposited onto the surface of the capture well. A known amount of developer is deposited into the input well, flows through the input channel and floods the capture well. A colour change is produced proportional to the amount of target antigen which was present into the fluidic sample to be analysed. The LED lights are sequentially switched on/off. Readings from the detector are used to detect the concentration of ‘N’ different antigens present into the fluidic sample to be analysed.

In a second example embodiment, a microfluidic chip made of silicon containing ‘N’ quantification systems are used. All capture wells are coated with at least one capture antibody. In this particular embodiment there are ‘N’ capture wells, one per quantification system. In this particular embodiment each capture well is coated with a different capture antibody. In this particular embodiment the bottom of the capture well is the top electrode of an oscillating sensor, for example a miniaturised quartz crystal microbalance, which has been integrated with (or built within) the silicon chip. All detection wells are coated with at least one detection antibody. In this particular embodiment there are ‘N’ detection wells, one per quantification system. In this particular embodiment each detection well is coated with a different detection antibody. In this particular embodiment there is one connecting channel between each pair of capture and detection wells. In this particular embodiment there is one actively controlled blocking agent at each connecting channel. In this particular embodiment all blocking agents are initially blocking the connecting channel. In this particular embodiment there is one input well. In this particular embodiment there is one output well. In this particular embodiment there is one input channel connecting the input well and capture well. In this particular embodiment there is one output channel connecting the capture well and output well. Both the capture and detection wells are coated with capture and detection antibodies using a loading machine. The microfluidic chip is introduced into the device. In this particular embodiment the device has electrical connections under the capture well to drive the oscillating sensor. In this particular embodiment the device has embedded electronics to measure the frequency change of the oscillating sensor.

In this particular embodiment the fluidic sample to be analysed, perhaps containing a target antigen is deposited into the input well. The fluidic sample to be analysed flows through the input channel, floods the capture well and exits through the output channel. The target antigen if present in the sample to be analysed, binds specifically to the capture antibody immobilised at the surface of the capture well. Abundant clean fluid, for example buffer, is deposited into the input well, flows through the input channel, floods the capture well and exits through the output channel, cleaning loose agents deposited onto the surface of the capture well. The blocking agents are now switched to unblock the connecting channels. A known amount of carrier fluid is deposited into the input well. The carrier fluid flows through the input channel, floods the capture well, flows through the connecting channel and floods the detection well. The detection antibody is transported through the fluid by diffusion and binds to the target antigen, if present, which was immobilised at the surface of the capture well. Abundant clean fluid, for example buffer, is deposited into the input well, flows through the input channel, floods the capture well and exits through the output channel, cleaning loose agents deposited onto the surface of the capture well. Fluid containing gold nanoparticles bound to secondary antibodies is deposited into the input well, flows through the input channel, flows through the capture well and exits through the output channel. Gold nanoparticles linked antibodies bind to the detection antibody, if present. Abundant clean fluid, for example buffer, is deposited into the input well, flows through the input channel, floods the capture well and exits through the output channel, cleaning loose agents and particles deposited onto the surface of the capture well. The oscillating sensors are activated sequentially and the device embedded electronics read the frequency shift. Readings from the sensors are used to detect the concentration of ‘N’ different antigens present into the fluidic sample to be analysed.

Thus, microfluidic devices incorporating a valve for selectively controlling the flow of a fluid within the microfluidic device and a microfluidic sensing platform have been described. Although embodiments have been described with reference to specific example embodiments, it will be evident that various modifications and changes can be made to these example embodiments without departing from the broader spirit and scope of the present application. For example, such changes could include, but are not limited to, variations in the force used to actuate the valve membranes, variations in the rigid and soft materials, and variations and/or additions of further fluid or control layers. Accordingly, the specification and drawings are to be regarded in an illustrative rather than a restrictive sense.

The present disclosure has also particular utility in methods to therapeutically or prophylactically treat a subject. The subject is preferably an animal, more preferably a mammal and even more preferably, a human. Although it is envisaged that the present disclosure is also applicable to veterinary subjects.

The disclosure of every patent, patent application, and publication cited herein is hereby incorporated herein by reference in its entirety.

The citation of any reference herein should not be construed as an admission that such reference is available as “Prior Art” to the instant application.

Throughout the specification the aim has been to describe the preferred embodiments of the present disclosure without limiting the disclosure to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the appended claims.

What is claimed is:

1. A micro fluidic valve assembly comprising:
a rigid substrate having at least two adjacent layers defining a fluid channel, wherein the at least two adjacent layers include a first layer and a second layer;
at least one valve member positioned adjacent to the second layer; and
at least two through-holes in said second layer configured to facilitate a communication between the fluid channel and the valve member to facilitate the flow of the test fluid substantially adjacent to the fluid channel.

2. The microfluidic valve assembly of claim 1, further comprising a pillar member, wherein the test fluid flows over the pillar member when an external pressure over the valve member is less than the pressure of the test fluid.

3. The microfluidic valve assembly of claim 2, wherein the test fluid flows back into the fluid channel through the through hole.

4. The microfluidic valve assembly of claim 1, wherein the cross sectional area of the valve member is different from a cross sectional area of the fluid channel.

5. The microfluidic valve assembly of claim 1, wherein the valve is fabricated in the topside of the second layer.

6. The microfluidic valve assembly of claim 1, wherein the depth of the valve member is shallower than the fluid channel.

7. The microfluidic valve assembly of claim 1, wherein the stretchable membrane of the valve member is embedded with conductive or magnetic beads.

8. The microfluidic valve assembly of claim 1, wherein the valve member is configured to be actuated via electric or magnetic power.

9. The microfluidic valve assembly of claim 1, wherein the valve member is above the second layer.

10. The microfluidic valve assembly of claim 1, wherein the test fluid flows substantially above to the fluid channel.
